(19) United States
(12) Patent Application Publication
(10) Pub. No.: US 2022/0005046 A1
(43) Pub. Date: Jan. 6, 2022

(54) PAYMENT METHOD USING BIOMETRIC AUTHENTICATION AND ELECTRONIC DEVICE THEREFOR

(71) Applicant: Samsung Electronics Co., Ltd., Suwon-si, Gyeonggi-do (KR)

(72) Inventors: Inho KIM, Suwon-si (KR); Wanseok KIM, Suwon-si (KR); Yongseok PARK, Suwon-si (KR); Yongwan LEE, Suwon-si (KR); Jinwook CHUN, Suwon-si (KR)

(21) Appl. No.: 17/290,579

(22) PCT Filed: Nov. 1, 2019
(86) PCT No.: PCT/KR2019/014750

§ 371 Date: Apr. 30, 2021

(30) Foreign Application Priority Data
Nov. 2, 2018 (KR) 10-2018-0133898

(51) Int. Cl. G06Q 20/40; G06Q 20/38

(52) U.S. Cl. CPC G06Q 20/40145; G06Q 20/38215; G06Q 20/3829

(57) ABSTRACT

Various embodiments of the disclosure relate to a payment method using biometric authentication, and an electronic device thereof. The electronic device includes a communication module configured to provide communication with a server, a processor operatively coupled to the communication module, and a memory operatively coupled to the processor and configured to store biometric information. The memory may store instructions, when executed, causing the processor to, when registered for a first time use, generate a parameter for biometric authentication verification and an encrypted password for password authentication verification and transmit the generated parameter and password to the server, in order to register, with the server, biometric authentication information for biometric authentication verification and a password for password authentication, when a payment is made, use at least one of the biometric authentication and the password authentication to authenticate a user, and when it is necessary to change the biometric authentication information registered with the server, register new biometric authentication information with the server in the process of the payment.

### TECHNICAL FIELD

Various embodiments of the disclosure relate to a payment method using biometric authentication and an electronic device thereof.

### BACKGROUND ART

User authentication is frequently required for an online or offline payment. User authentication using a user Identification (ID) and a password has been widely used as a user authentication method. A user authentication method using biometric information has also been suggested.

An example of user authentication using existing biometric information may include a Fast Identity Online (FIDO) standard. Apparently, registration, authentication, and deregistration procedures are present explicitly in the FIDO standard. Therefore, according to the FIDO standard, when biometric information is not registered through an FIDO client and an FIDO server or when an error such as an authentication failure occurs, biometric information is additionally registered again, and then an authentication procedure is sequentially performed.

### DISCLOSURE OF INVENTION

### Technical Problem

According to the conventional Fast Identity Online (FIDO) standard, re-registration of biometric information for user authentication and new registration caused by error occurrence are followed by authentication, which results in inconvenience in terms of usability, such as taking a considerable amount of time for authentication.

Various embodiments of the disclosure provide a payment method and electronic device thereof in which an authentication issuing server can directly perform biometric authentication efficiently and conveniently, and simultaneously perform registration and authentication.

### Solution to Problem

According to various embodiments of the disclosure, an electronic device includes a communication module configured to provide communication with a server, a processor operatively coupled to the communication module, and a memory operatively coupled to the processor and configured to store biometric information. The memory may store instructions, when executed, causing the processor to, when registered for a first time use, generate a parameter for biometric authentication verification and an encrypted password for password authentication verification and transmit the generated parameter and password to the server, in order to register, with the server, biometric authentication information for biometric authentication verification and a password for password authentication, when a payment is made, use at least one of the biometric authentication and the password authentication to authenticate a user, and when it is necessary to change the biometric authentication information registered with the server, register new biometric authentication information with the server in the process of the payment.

According to various embodiments of the disclosure, a server includes a communication module configured to provide communication with an electronic device, a processor operatively coupled to the communication module, and a memory operatively coupled to the processor and configured to store biometric authentication information. The memory may store instructions, when executed, causing the processor to, when registered for a first time use, receive a parameter for biometric authentication verification and an encrypted password for password authentication verification from the electronic device, store the password in the memory by decoding the encrypted password, and store, in the memory, biometric authentication information obtained by verifying biometric authentication, based on the parameter for biometric authentication verification, when a payment is made using the biometric authentication, verify biometric authentication, based on the received parameter for biometric authentication verification and the stored biometric authentication information, when the payment is made using the password authentication, verify password authentication by comparing a password obtained from the received encrypted password and the password stored in the memory, and when new registration for the biometric authentication information is necessary, store, in the memory, new biometric authentication information registered while the payment is made using the biometric authentication.

According to various embodiments of the disclosure, a method of operating an electronic device includes, when registered for a first time use, generating a parameter for biometric authentication verification and an encrypted password for password authentication verification and transmitting the generated parameter and password to the server, in order to register, with the server, biometric authentication information for biometric authentication verification and a password for password authentication, when a payment is made, performing user authentication by using at least one of the biometric authentication and the password authentication, and when it is necessary to change the biometric authentication information registered with the server, registering new biometric authentication information with the server in the process of the payment.

According to various embodiments of the disclosure, a method of operating a server, when registered for a first time use, includes receiving a parameter for biometric authentication verification and an encrypted password for password authentication verification from the electronic device, storing the password in the memory by decoding the encrypted password, and storing, in the memory, biometric authentication information obtained by verifying biometric authentication, based on the parameter for biometric authentication verification. When a payment is made, the method includes verifying biometric authentication, based on the received parameter for biometric authentication verification and the stored biometric authentication information, and/or verifying password authentication by comparing a password obtained from the received encrypted password and the password stored in the memory, and when new registration for the biometric authentication information is necessary, storing, in the memory, new biometric authentication information registered while the payment is made using the biometric authentication.

### Advantageous Effects of Invention

In a method and electronic device thereof according to various embodiments, an authentication issuing server can directly perform biometric authentication efficiently and conveniently, thereby solving problems in that services cannot be simultaneously used due to public use of a biometric authentication server, and eliminating system complexity. In addition, maintainability and security can be improved, and cost caused by paying usage fees can be eliminated.

In a method and electronic device thereof according to various embodiments, registration and authentication are performed simultaneously, thereby solving a time delay problem caused by additional processing and improving user's usability.

### BRIEF DESCRIPTION OF DRAWINGS

FIG. 1 is a block diagram of an electronic device in a network environment according to various embodiments;

FIG. 2 is a block diagram illustrating a program according to various embodiments;

FIG. 3 is a block diagram illustrating a Rich Execution Environment (REE) and Trusted Execution Environment (TEE) operating in an electronic device according to various embodiments;

FIG. 4 is a system architecture for a payment method using biometric authentication according to various embodiments;

FIG. 5 is a flowchart illustrating a procedure of registering user authentication information according to various embodiments;

FIG. 6 is a flowchart illustrating a procedure of performing an online payment according to various embodiments;

FIG. 7 is a flowchart illustrating a procedure of deleting payment-related information and user authentication information according to various embodiments;

FIG. 8 is a flowchart illustrating a recovery procedure through password authentication depending on a failure in verification based on biometric authentication according to various embodiments;

FIG. 9 is a flowchart illustrating an operation of an electronic device for registering payment information and user authentication information according to various embodiments;

FIG. 10 is a flowchart illustrating an operation of an electronic device for biometric authentication according to various embodiments;

FIG. 11 is a flowchart illustrating an operation of an electronic device for password authentication according to various embodiments;

FIG. 12 is a flowchart illustrating a payment operation of an electronic device according to various embodiments;

FIG. 13 is a flowchart illustrating an operation of an issuer server for registering payment information and user authentication information according to various embodiments;

FIG. 14 is a flowchart illustrating an operation of an issuer server when a payment is made, according to various embodiments;

FIG. 15 is a flowchart illustrating an operation of an issuer server when a payment is made after biometric authentication information is initialized by a recovery procedure according to various embodiments;

FIG. 16 is a flowchart illustrating an operation of an issuer server for biometric authentication verification according to various embodiments;

FIG. 17 is a flowchart briefly illustrating an operation of an electronic device for user authentication according to various embodiments;

FIG. 18 is a flowchart illustrating an authentication procedure of an electronic device when a payment is made depending on a biometric authentication information storage state of the electronic device and a biometric authentication information registration state of an issuer server according to various embodiments;

FIG. 19A to 19F illustrates an example displayed on a display device when a recovery procedure is performed through password authentication due to a failure in biometric authentication verification when a payment is made based on FIG. 14 according to various embodiments

### BEST MODE FOR CARRYING OUT THE INVENTION

Hereinafter, various embodiments will be described in detail with reference to the accompanying drawings.

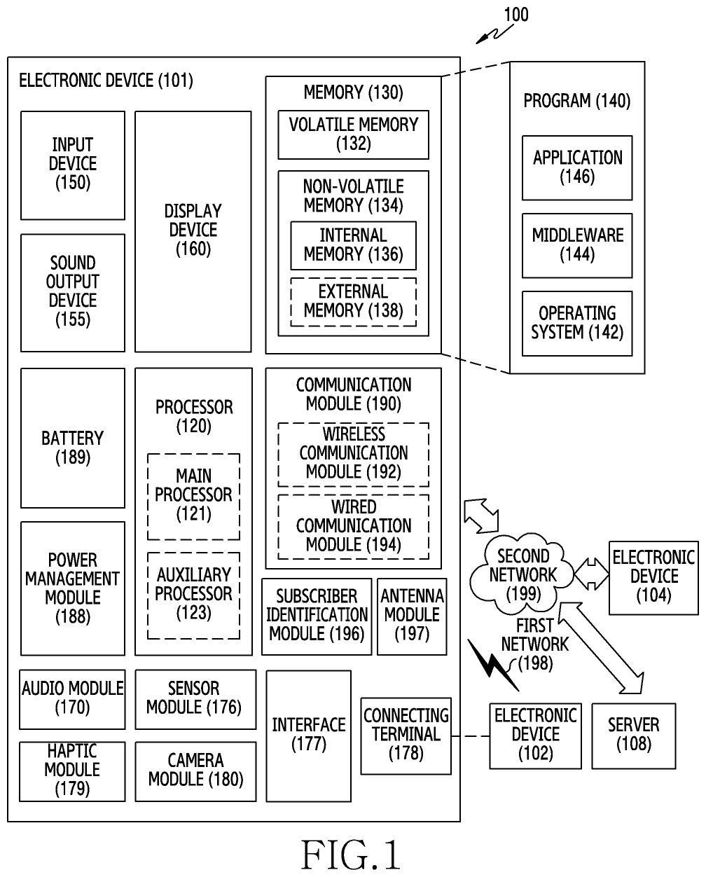

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

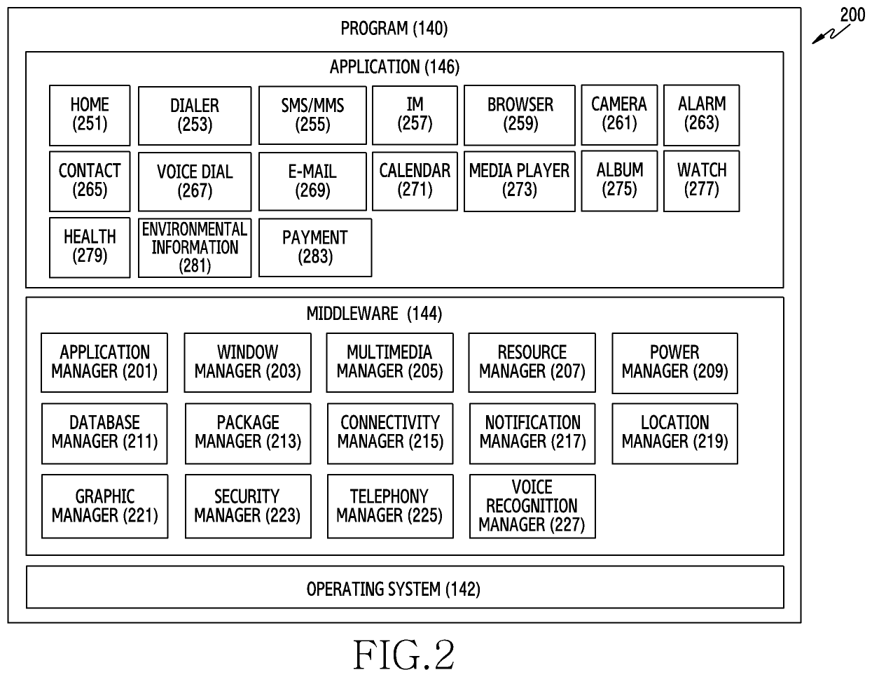

FIG. 2 is a block diagram 200 illustrating the program 140 according to various embodiments. According to an embodiment, the program 140 may include an Operating System (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more Graphical User Interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a Basic Input/Output System (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify the user of an occurrence of a specified event (e.g., an incoming call, message, or alert). The location manager 219, for example, may manage locational information on the electronic device 101. The graphic manager 221, for example, may manage one or more graphic effects to be offered to the user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, Short Message Service (SMS)/Multimedia Messaging Service (MMS) 255, Instant Message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to the user of the electronic device 101.

The device management application may control, for example, the power (e.g., turn-on or turn-off) or the function (e.g., adjustment of brightness, resolution, or focus) of the external electronic device or some component thereof (e.g., a display device 160 or a camera module 180) communicating with the electronic device 101. The device management application, additionally or alternatively, may support installation, delete, or update of an application running on the external electronic device.

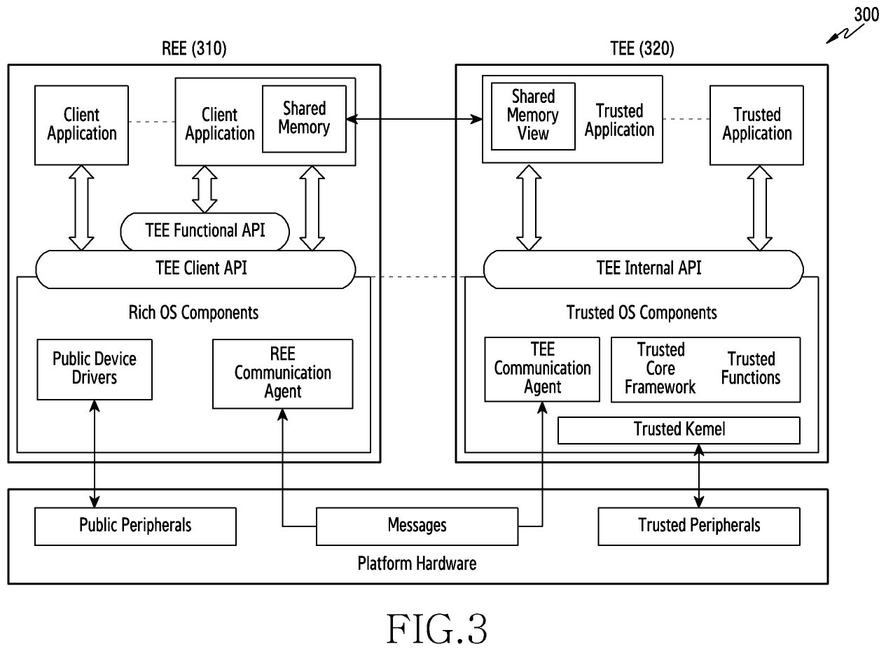

FIG. 3 is a block diagram 300 illustrating a Rich Execution Environment (REE) and Trusted Execution Environment (TEE) operating in an electronic device (e.g., the electronic device 101) according to various embodiments. According to various embodiments, the electronic device may operate an execution environment having a plurality of security levels to enhance security. The plurality of execution environments may include, for example, an REE 310 and a TEE 320. The REE may be, for example, a first execution environment having a first security level. The TEE may be, for example, a second execution environment having a second security level different from (e.g., higher than) the first security level. According to an embodiment, the electronic device 101 may include a third execution environment having a third security level, but the disclosure is not limited thereto.

The TEE 320 may store data requiring a relatively high security level in a safe environment and perform related operations. The TEE 320 may operate on an application processor of the electronic device, and may operate based on a reliable hardware structure determined in a manufacturing process of the electronic device. The TEE 320 may operate in a security region by dividing the application processor or memory into a general region and a security region. The TEE 320 may configure software or hardware requiring security to operate only in the security region. The electronic device may operate a TEE through a physical change of hardware or a logical change of software. The TEE 320 may be referred to as an Embedded Secure Element (ESE), a secure element, or a trust zone.

The TEE 320 may be separated from the REE 310 through a hardware constraint, and may operate by being separated on the same hardware in a software manner. At least one application (e.g., a payment, a contact, an e-mail, a browser, etc.) operating in the REE 310 may use an API (e.g., a TEE functional API or a TEE client API) which is allowed to access the TEE 320. The at least one application may transfer a message from a communication agent of the REE (an REE communication agent) to a communication agent of the TEE (a TEE communication agent) by using the API. The message may be implemented to be transferred only to the TEE 320 in a hardware manner. The communication agent of the TEE may receive the message and transfer it to a Trusted Application (TA) related to the message (e.g., a DRM, a secure payment module, a secure biometric information module, etc.). The TA may perform an operation related to the message, and may transfer a result for the operation to the communication agent of the REE through the communication agent of the TEE. The communication agent of the REE may transfer the result to at least one application operating in the REE.

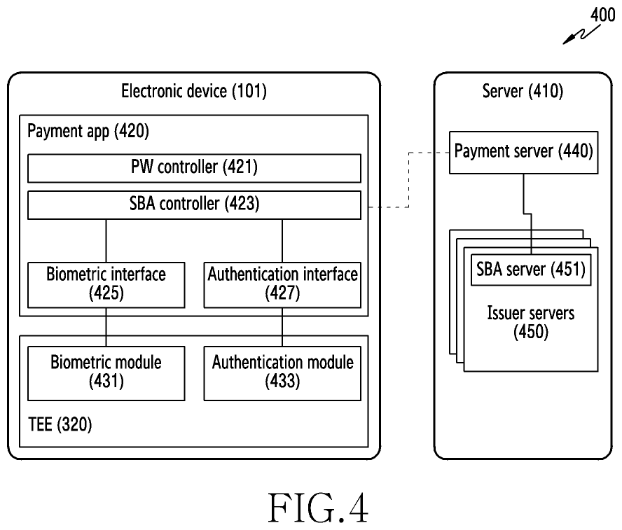

FIG. 4 is a system architecture 300 for a payment method using biometric authentication according to various embodiments. An electronic device 101 may include various components illustrated in FIG. 1, but only necessary components are shown in FIG. 4 for simplicity of description. A server 410 may be included in the server 108 of FIG. 1, and the server 410 and the electronic device 101 may communicate with each other using the first network 198 and/or the second network 199.

According to various embodiments, the electronic device 101 may include a payment app 420, a biometric module 431, and an authentication module 433 to perform a payment. The payment app 420 may operate in the REE 310, and the biometric module 431 and the authentication module 433 may operate in the TEE 320. The payment app 420, the biometric module 431, and the authentication module 433 may operate in one or more processors (e.g., the processor 120 of FIG. 1), and may operate in the same processor or different processors according to a security environment operating method of the electronic device 101.

According to various embodiments, the payment app 420 may be one of the applications 146 of FIG. 1 or FIG. 2, and may be executed when a user attempts the payment.

According to various embodiments, the payment app 420 may include a PassWord (PW) controller 421, a Simple Bio Auth (SBA) controller 423, a biometric interface 425, and an authentication interface 427.

The PW controller 421 may transfer to an issuer server 450 a password which is input from the user so as to be used in authentication by being registered with an issuer such as a credit card company, a bank, or a micropayment agency. In addition, password registration to be performed by the PW controller 421 is achieved when registered for a first time use, and password authentication to be performed by the PW controller 421 may be used in a case where biometric authentication is reset or user authentication is performed instead of biometric authentication due to a failure in the biometric authentication performed when the payment is made or when payment information is deleted. Herein, the password may include a Personal Identification Number (PIN), a number, a pattern, a combination of alphabetic characters/numbers, and a combination of alphabetic characters/numbers/symbols.

The SBA controller 423 may perform an integrated control function related to biometric authentication to store an original biometric verification value (nonce) received from the issuer server 450, may control a biometric authentication flow with respect to the biometric module 431 and the authentication module 433 to generate a parameter for final biometric authentication verification, and may transfer the generated parameter to the issuer server 450. The SBA controller 423 may request the authentication module 433 for an object reference value randomly generated for data verification and security between the authentication module 433 and the biometric module 431 and may receive the provided object reference value. The SBA controller 423 may transfer the object reference value to the biometric module 431, and may receive an encrypted secure object from the biometric module 431 so that the object reference value can be decoded only in the authentication module 433 according to a biometric authentication result. The SBA controller 423 may transfer to the authentication module 433 ‘original data’ (also referred to as a final challenge) including the secure object, the original biometric verification value, and an app signature hash value for identifying forgery and falsification of an app, and may receive three authentication parameters from the authentication module 433. The three authentication parameters may include ‘signed original data’ (also referred to as a final challenge signed) in which the original data is signed with a biometric signature private key (e.g., cbioPRV), ‘encrypted original data’ (also referred to as a final challenge encrypted) in which the original data is encrypted with a public key (e.g., sPUK) provided by the issuer server 450, and a biometric authentication public key (e.g., cbioPUK) to be used in the issuer server 450 to verify biometric authentication. The SBA controller 423 may transfer the generated three parameters to the issuer server 450 to request for user authentication using biometric authentication.

The biometric interface 425 may transfer or receive a message according to an interface defined for message or signal transmission between the payment app 420 and the biometric module 431 in the TEE 320. The authentication interface 427 may transfer or receive a message according to an interface defined for message or signal transmission between the payment app 420 and the authentication module 433 in the TEE 320. The biometric interface 425 and the authentication interface 427 may be an API permitted to access the TEE 320.

According to various embodiments, as a module which operates in the TEE 320, the biometric module 431 is a module which encrypts and generates a result of biometric authentication in the electronic device 101, and transfers it to the payment app 420. The biometric module 431 may perform biometric authentication based on unique information which can be obtained from user's biometric information, and may perform biometric authentication based on a fingerprint, an iris, or the like. The biometric module 431 may obtain biometric information from the user and store it in a memory in the TEE 320 when registered for the first time or when biometric information needs to be stored. When the biometric information is pre-stored, the biometric module 431 may compare the stored biometric information with biometric information which is input by the user, and may determine that the biometric authentication is achieved if the comparison result is identical, and may determine that the biometric authentication is not achieved if the comparison result is not identical. Determination on whether the biometric information is pre-stored may be based on information indicating a biometric authentication information storage state. The biometric module 431 may generate the secure object in which the object reference value transferred from the SBA controller 423 is encrypted, based on a biometric authentication result. According to various embodiments, the biometric module 431 may generate the secure object in which the object reference value is encrypted, only when it is determined that the biometric authentication is achieved. The biometric module 431 may transfer the generated secure object to the SBA controller 423.

According to various embodiments, as a module which operates in the TEE 320, the authentication module 433 is a module which identifies a result value of biometric authentication generated by the biometric module 431 to sign a biometric authentication final result value to be transferred to the issuer server 450. The authentication module 433 may generate and transfer an object reference value at the request of the SBA controller 423, and may decode a secure object received through the SBA controller 423 and generated by the biometric module 431 to determine whether biometric authentication is achieved. If there is no key pair previously generated, the authentication module 433 may generate a private key (e.g., cbioPRV) and public key (cbioPUK) pair for biometric authentication, and may generate three parameters for biometric authentication verification by applying this key pair to original data transferred from the SBA controller 423.

According to various embodiments, the server 410 may include the payment server 440 and the at least one issuer server 450. The payment server 440 may perform a function of transmitting data between the payment app 420 and the at least one issuer server 450 by serving as a gateway in relation to the biometric authentication flow, and may perform a function of storing a public key issued by the at least one issuer server 450 and providing it to the payment app 420. The at least one issuer server 450 may generate, store, and control the original biometric verification value (nonce) for each user, may store and manage a public key generated by the payment app 420 for the purpose of signature verification, and may authenticate the user by verifying a final biometric authentication result value transferred from the payment app 420. Herein, the issuer server 450 may randomly generate the original biometric verification value. Each of the at least one issuer server 450 may include a communication module for performing communication with other electronic devices (e.g., the electronic device 101 and the payment server 450), a memory for storing biometric authentication information required for verification, and a Simple Bio Auth (SBA) server 451 which operates in response to the payment app 420.

According to various embodiments, an electronic device includes a communication module configured to provide communication with a server, a processor operatively coupled to the communication module, and a memory operatively coupled to the processor and configured to store biometric information. The memory may store instructions, when executed, causing the processor to, when registered for a first time use, generate a parameter for biometric authentication verification and an encrypted password for password authentication verification and transmit the generated parameter and password to the server, in order to register, with the server, biometric authentication information for biometric authentication verification and a password for password authentication, when the payment is made, use at least one of the biometric authentication and the password authentication to authenticate a user, and when it is necessary to change the biometric authentication information registered with the server, register new biometric authentication information with the server in the process of the payment.

According to various embodiments, the memory may store information indicating a biometric authentication information storage state. The instructions may cause, when the payment is made, the processor to request the server for an original biometric verification value, receive, in response to the request, information indicating the original biometric verification value and a biometric authentication information registration state from the server, and perform user authentication by using biometric authentication and/or password authentication, based on the received information indicating the biometric authentication information registration state and the information indicating the biometric authentication information storage state.

According to various embodiments, the instructions, when the payment is made, may cause the processor to perform user authentication by using biometric authentication when the information, received from the server, indicating the biometric authentication information registration state is in a registered state and the information indicating the biometric authentication information storage state is in a stored state, perform user authentication by using biometric authentication when the information, received from the server, indicating the biometric authentication information registration state is in an unregistered state and the information indicating the biometric authentication information storage state is in an unstored state, perform user authentication by using password authentication when the information, received from the server, indicating the biometric authentication information registration state is in the unregistered state and the information indicating the biometric authentication information storage state is in the stored state, and change the biometric authentication information storage state to the unstored state after the performing of the user authentication is complete, and perform user authentication by using password authentication when the information, received from the server, indicating the biometric authentication information registration state is in the registered state and the information indicating the biometric authentication information storage state is in the unstored state, and after the performing of the user authentication is complete, request the server to change the information indicating the biometric authentication information registration state to be in the unregistered state.

According to various embodiments, the instructions, when the payment is made, may cause the processor to transmit the parameter for biometric authentication verification to the server, receive a biometric authentication verification result from the server, if the received verification result is a verification failure, transmit an encrypted password for password authentication verification to the server, receive a password verification result from the server, and if the received verification result is a verification success, change the information indicating the biometric authentication information storage state to the unstored state, and request the server to change the information indicating the biometric authentication information registration state to be in the unregistered state.

According to various embodiments, the instructions, when the payment is made, may cause the processor to generate an object reference value, generate a secure object in which the object reference value is encrypted, generate original data including the original biometric verification value, the secure object, and a hash value indicating an app used for the payment, and generate the parameter for biometric authentication verification, based on the original data.

According to various embodiments, the instructions, when the payment is made, may cause the processor to, when information indicating the biometric authentication information storage state is in an unstored state, generate a biometric authentication private key/public key pair and store the key pair in the process of performing biometric authentication. The parameter for biometric authentication verification may include ‘signed original data’ in which the original data is signed with the biometric authentication private key, ‘encrypted original data’ in which the original data is encrypted with a public key provided in the server, and the biometric authentication public key.

According to various embodiments, a server includes a communication module configured to provide communication with an electronic device, a processor operatively coupled to the communication module, and a memory operatively coupled to the processor and configured to store biometric authentication information. The memory may store instructions, when executed, causing the processor to, when registered for a first time use, receive a parameter for biometric authentication verification and an encrypted password for password authentication verification from the electronic device, store the password in the memory by decoding the encrypted password, and store, in the memory, biometric authentication information obtained by verifying biometric authentication, based on the parameter for biometric authentication verification, when a payment is made using the biometric authentication, verify biometric authentication, based on the received parameter for biometric authentication verification and the stored biometric authentication information, when the payment is made using the password authentication, verify password authentication by comparing a password obtained from the received encrypted password and the password stored in the memory, and when new registration for the biometric authentication information is necessary, store, in the memory, new biometric authentication information registered while the payment is made using the biometric authentication.

According to various embodiments, the memory may store information indicating a biometric authentication information registration state. The instructions, when the payment is made, may cause the processor to receive a request for an original biometric authentication value from the electronic device, and transmit, in response to the request, information indicating the original biometric verification value and the biometric authentication information registration state to the electronic device.

According to various embodiments, the instructions, when the payment is made, may cause the processor to receive the parameter for biometric authentication verification from the electronic device, verify biometric authentication, based on the parameter for biometric authentication verification and the stored biometric authentication information, transmit a result of the biometric authentication verification to the electronic device, if the result of the biometric authentication verification is a verification failure, receive the encrypted password from the electronic device, verify password authentication by comparing a password obtained from the received encrypted password and the password stored in the memory, transmit a result of the password verification to the electronic device, if the result of the password verification is a verification success, receive from the electronic device a request for changing information indicating the biometric authentication information registration state to be in an unregistered state, and change the information indicating the biometric authentication information registration state to the unregistered state.

According to various embodiments, the instructions, when the payment is made, may cause the processor to receive the parameter for biometric authentication verification from the electronic device, verify biometric authentication, based on the parameter for biometric authentication verification, if the verification result is a success, register biometric authentication information obtained from the parameter for biometric authentication verification, by storing the biometric authentication information in the memory, and transmit the verification result to the electronic device.

According to various embodiments, the parameter for biometric authentication verification may include ‘signed original data’ in which original data is signed with a biometric authentication private key generated by the electronic device, ‘encrypted original data’ in which the original data is encrypted with a public key generated in the server, and a biometric authentication public key generated by the electronic device.

According to various embodiments, the instructions, when the payment is made, may cause the processor to identify validity of the parameter for biometric authentication verification, obtain original data by decoding the encrypted original data with a private key of the server, identify whether an app used in the payment is legitimate by using a hash value included in the decoded original data and indicating the app to be used in the payment, determine whether the original biometric verification value is identical to an original biometric verification value included in the decoded original data, determine whether a specific period of time elapses after the original biometric verification value is issued, identify whether the biometric authentication public keys included in the stored biometric authentication information and the parameter for biometric authentication verification are identical, and perform the biometric authentication verification by verifying a signature of the signed original data.

Hereinafter, an operation for user registration, payment, and deletion will be described based on the aforementioned configuration.

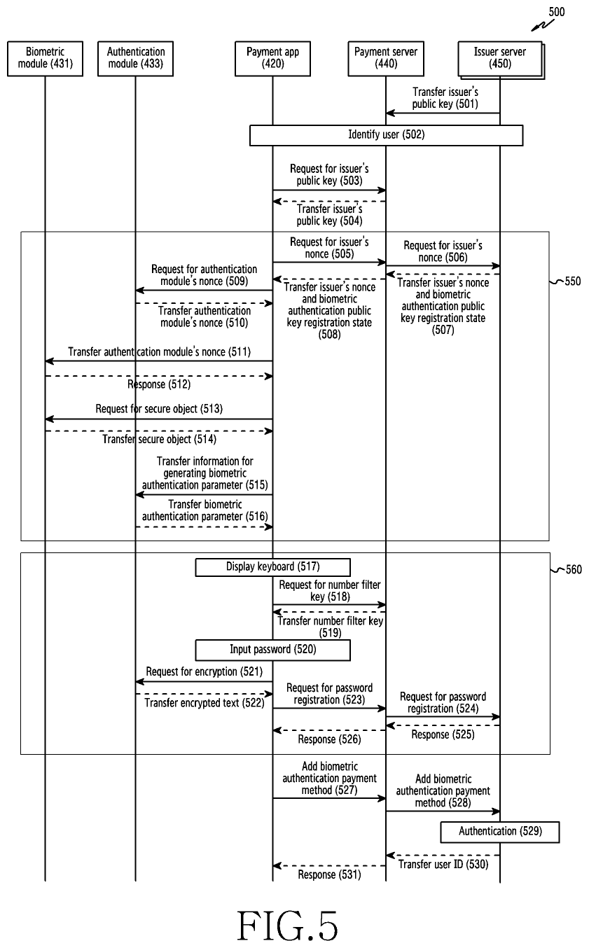

FIG. 5 is a flowchart 500 illustrating a procedure of registering user authentication information according to various embodiments.

Referring to FIG. 5, in operation 501, the issuer server 450 generates a public key/private key thereof and then transfers the public key (e.g., sPUK) to the payment server 440. The public key may be transferred offline, and when there are multiple issuer servers 450, a public key corresponding to each of the issuer servers 450 may be transferred to the payment server 440.

According to an embodiment in operation 502, the payment app 420 may provide user information and payment-related information including a card to be used or a phone number for a micropayment, and may identify whether a corresponding user is a legitimate user. In operation 503, the payment app 420 requests the payment server 440 for the public key of the issuer server 450. In operation 504, the payment server 440 may transfer to the payment app 420 the public key of the issuer server 450, corresponding to information to be registered among stored public keys.

According to various embodiments, when registered for the first time, after identifying the user in operation 502, a biometric authentication process 550 and a password authentication process 560 may be performed so that the biometric authentication information and the password are registered with the issuer server 450.

According to various embodiments, in operation 505, the payment app 420 may request the issuer server 450 for an original biometric verification value. In operation 506, the payment server 440 may transfer this request to the issuer server 450. In operation 507, the issuer server 450 may randomly generate the original biometric verification value and transfer to the payment server 440 the generated original biometric verification value and a registration state parameter indicating a biometric authentication information registration state. In operation 508, the payment server 440 may transfer to the payment app 420 the transferred original biometric verification value and registration state parameter. The biometric authentication information may be a biometric authentication public key (e.g., cbioPUK) received by the issuer server 450 from the payment app 420. The registration state parameter may have a value corresponding to ‘true’ or a value corresponding to ‘false’. If it is ‘true’, it may indicate that the biometric authentication information is in a registered state, and if it is ‘false’, it may indicate that the biometric authentication information is in an unregistered state. In case of first-time registration, since the biometric authentication public key is not registered yet, the registration state parameter may have a value corresponding to ‘false’.

According to various embodiments, in operation 509, the payment app 420 may request the authentication module 433 for an object reference value. In operation 510, the authentication module 433 may generate the object reference value and transfer it to the payment app 420. In operation 511, the payment app 420 may transfer to the biometric module 431 the object reference value transferred from the authentication module 433. In operation 512, the biometric module 431 may transfer to the payment app 420 a response indicating that the object reference value is received. In addition, in operation 513, the payment app 420 may request the biometric module 431 for a secure object. In operation 514, the biometric module 431 may obtain biometric information from the user and store it, and then transfer an encrypted secure object to the payment app 420 so that only the authentication module 433 can decode the object reference value.

According to various embodiments, in operation 515, for biometric authentication, the payment app 420 may transfer information for generating a biometric authentication parameter to the authentication module 433. The transferred information may include the secure object received from the authentication module 433, original data including the original biometric verification value transferred from the issuer server 450 and an app signature hash value for identifying forgery and falsification of an app, and a public key of the issuer server 450. The app signature hash value may be an app IDentification (ID) capable of recognizing the app.

According to various embodiments, the authentication module 433 may generate a biometric authentication private key/public key pair when there is no biometric authentication private key/public key pair previously generated. In case of first-time registration, since there is no biometric authentication private key (e.g., cbioPRV)/public key (e.g., cbioPUK) pair, a new biometric authentication private key/public key pair may be generated. The authentication module 433 may verify whether the object reference value extracted by decoding the secure object is identical to the object reference value transferred to the payment app 420 in operation 510 to identify whether biometric registration or authentication is achieved. After the verification of the object reference value is complete, the authentication module 433 may generate ‘signed original data’ as a first parameter in which original data is signed with a biometric authentication private key and ‘encrypted original data’ as a second parameter in which the original data is encrypted with a public key (e.g., sPUK) provided by the issuer server 450. In operation 516, three parameters including the first parameter, the second parameter, and a third parameter which is a biometric authentication public key (e.g., cbioPUK) to be used in the issuer server 450 to verify biometric authentication may be transferred to the payment app 420 as the parameter for biometric authentication verification.

According to various embodiments, for password authentication, in operation 517, the payment app 420 may display a secure keypad on a display device (e.g., the display device 160 of FIG. 1) so that the user inputs a password. In operation 518, the payment server 440 is requested to provide a number filter key of which a location is changed whenever each number is input to provide security for data to be transmitted. In operation 519, the number filter key may be received from the payment server 440 to display the secure keypad on the basis of the number filter key. In operation 520, the payment app 420 receives a password input from the user. In operation 521, the payment app 420 requests the authentication module 433 for encryption while transferring a public key (e.g., sPUK) of the issuer server and the input password to the authentication module 433. In operation 522, the payment app 420 may receive an encrypted text from the authentication module 433.

According to various embodiments, for password registration, in operation 523, the payment app 420 may transfer to the payment server 440 the encrypted text received from the authentication module 433. The payment server 440 may transfer the encrypted text to the issuer server 450 in operation 524, may receive from the issuer server 450 a response indicating that the password is registered in operation 525, and may transfer the registration response to the payment app 420 in operation 526, thereby completing the password registration.

According to various embodiments, in order to add a payment method using biometric authentication, in operation 527, the payment app 420 may transfer to the payment server 440 a payment method add request including a biometric authentication parameter obtained in the biometric authentication procedure of operations 505 to 516. In operation 528, the payment server 440 may transfer the received request to the issuer server 450. In operation 529, the issuer server 450 verifies a signature by using the transferred biometric authentication parameter, and stores a biometric authentication public key (e.g., cbioPUK) which is one of the transferred biometric authentication parameters. If the issuer server 450 has a response error occurring in the process of verifying the signature by using the biometric authentication, a registration process may be performed again from the beginning. Thereafter, in operation 530, the issuer server 450 transfers to the payment server 440 a user ID (e.g., a user account, a device ID, and a user-specific registration number for payment) for recognizing a registered user. The payment server 440 may store the user ID, and in operation 531, may transfer to the payment app 420 a response indicating that registration is complete, thereby completing registration of new payment information and user authentication information.

The following is description on a procedure of performing an online payment after payment information and user authentication information are registered according to the procedure of FIG. 5.

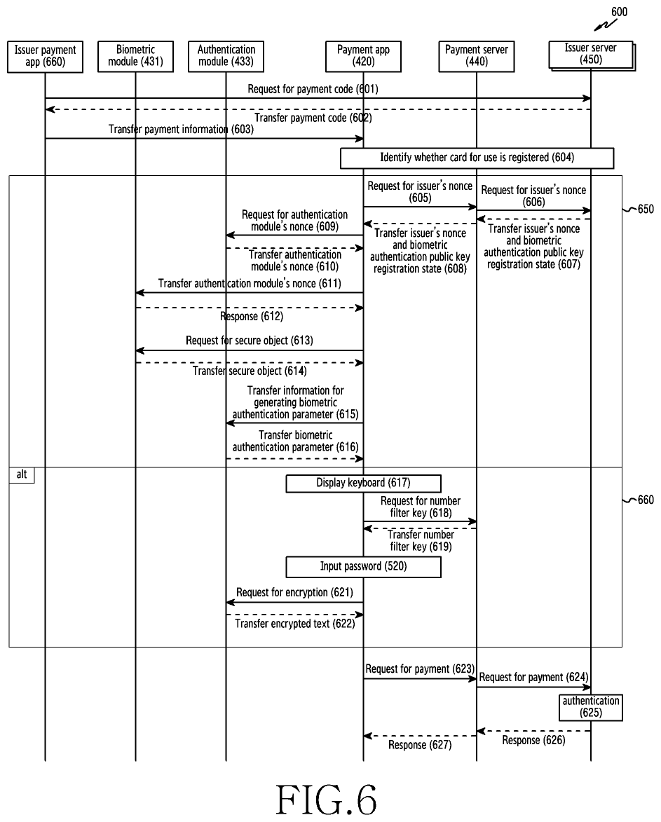

FIG. 6 is a flowchart 600 illustrating a procedure of performing an online payment according to various embodiments.

According to various embodiments, after a password and biometric authentication information for user identification are registered through registration for a first time use, the online payment may use a biometric authentication process 650 or a password authentication process 660 to request for a payment. Alternatively, after the payment is attempted through the biometric authentication process 650, if authentication verification fails, the payment may be requested by the password authentication process 660.

According to various embodiments, an issuer payment app 660 popped up in an online store may request the issuer server 450 for a payment code in operation 601, and may receive the payment code from the issuer server 450 in operation 602. In operation 603, the issuer payment app 660 may request for the payment while transferring payment information including the payment code, product information, and a product price to the payment app 420. In operation 604, the payment app 420 verifies whether the payment information is registered through the payment app 420 by communicating with the issuer server 450. If it is not registered, an additional procedure may be used to perform the registration. If it is registered, when a payment method based on biometric authentication is registered according to the procedure of FIG. 5, user authentication may be first performed by using the biometric authentication, and then the payment may be performed by using password authentication according to a condition. However, when a user selects the password authentication, the payment may be performed by using the password authentication without the biometric authentication.

According to various embodiments, in operation 605, the payment app 420 requests the issuer server 450 for an original biometric verification value. In operation 606, the payment server 440 transfers this request to the issuer server 450. In operation 607, the issuer server 450 generates the original biometric verification value, and transfers to the payment server 440 the generated original biometric verification value and a parameter (hereinafter, a registration state parameter) indicating a biometric authentication information registration state. In operation 608, the payment server 440 transfers to the payment app 420 the transferred original biometric verification value and registration state parameter.

According to various embodiments, a procedure to be performed by the payment app 420 may vary depending on the registration state parameter value and a state where the biometric authentication information is stored in the electronic device 101 in which the payment app 420 is executed. In an embodiment, when in a state where the biometric authentication information is stored in the electronic device 101 and when a registration state parameter value indicates ‘false’, or when in a state where the biometric authentication information is not stored in the electronic device 101 and the registration state parameter value indicates ‘true’ so that the registration state of the biometric authentication information is different between the electronic device 101 and the issuer server 450, user authentication using password authentication may be used to perform the payment. After the payment is complete, the registration state parameter value may be set to ‘false’, and a biometric authentication information storage state of the electronic device 101 may be set to an unstored state, thereby performing a recovery procedure through password authentication to match the both states.

In an embodiment, when in a normal state where the biometric authentication information is stored and the registration state parameter value is ‘true’, the electronic device 101 may perform the payment according to a procedure of FIG. 6 described below. In an embodiment, when the biometric authentication information is in an unstored state and the registration state parameter value is ‘false’, the electronic device 101 may perform the payment according to the procedure of FIG. 6 descried below, and allow to register the biometric authentication information during this procedure. Accordingly, the payment is performed while registering the biometric authentication information, thereby advantageously facilitating user convenience.

According to various embodiments, if the payment app 420 determines that the biometric authentication information storage state and the biometric authentication information registration statue are identical between the electronic device 101 and the issuer server 450, in operation 609, the payment app 420 may request the authentication module 433 for an object reference value. In operation 610, the authentication module 433 may generate the object reference value and transfer it to the payment app 420. In operation 611, the payment app 420 may transfer to the biometric module 431 the object reference value transferred from the authentication module 433. In operation 612, the biometric module 431 may transfer to the payment app 420 a response indicating that the object reference value is received. In addition, in operation 613, the payment app 420 may request the biometric module 431 for a secure object. In operation 614, when the biometric authentication information is in an unstored state, the biometric module 431 may obtain and store biometric information, and when the biometric authentication information is in a stored state, biometric authentication may be performed by comparing the stored biometric information with biometric information obtained from the user. According to a result thereof, an encrypted secure object may be transferred to the payment app 420 so that only the authentication module 433 can decode the object reference value.

According to various embodiments, in operation 615, for biometric authentication, the payment app 420 may transfer information for generating a biometric authentication parameter to the authentication module 433. The transferred information may include the secure object received from the authentication module 433, original data including the original biometric verification value transferred from the issuer server 450 and an app signature hash value for identifying forgery and falsification of an app, and a public key of the issuer server 450.

According to various embodiments, the authentication module 433 may generate a biometric authentication private key/public key pair when biometric authentication information is in an unstored state, that is, when there is no biometric authentication private key/public key pair previously generated. When in a state where the biometric authentication information is stored, a private key/public key previously stored may be directly used without having to generate a new biometric authentication private key/public key pair. The authentication module 433 may verify whether the object reference value extracted by decoding the secure object is identical to the object reference value transferred to the payment app 420 in operation 610 to identify whether biometric registration or authentication is achieved. After the verification of the object reference value is complete, the authentication module 433 may generate ‘signed original data’ as a first parameter in which original data is signed with a biometric authentication private key and ‘encrypted original data’ as a second parameter in which the original data is encrypted with a public key (e.g., sPUK) provided by the issuer server 450. In operation 616, three parameters including the first parameter, the second parameter, and a third parameter which is a biometric authentication public key (e.g., cbioPUK) to be used in the issuer server 450 to verify biometric authentication may be transferred to the payment app 420 as the parameter for biometric authentication verification.

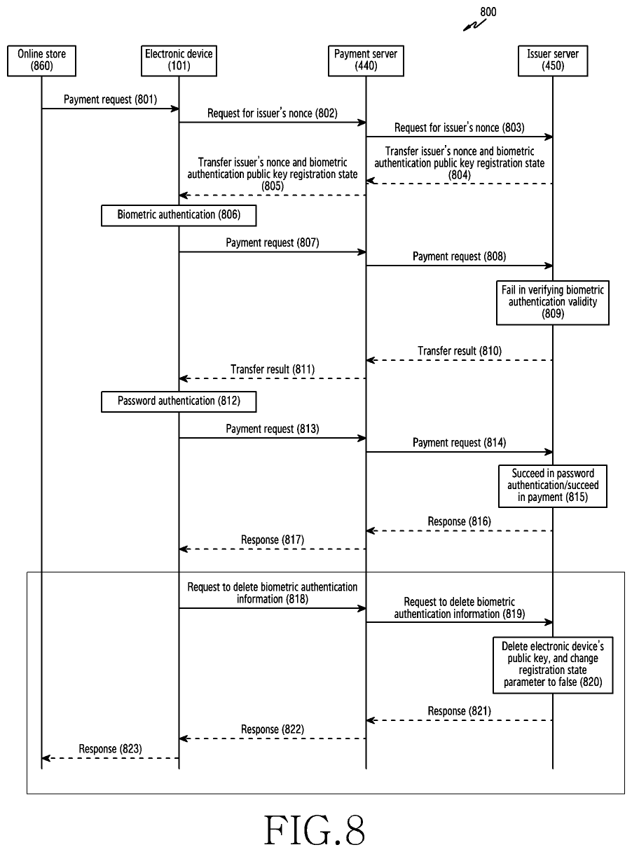

According to various embodiments, in operation 623, the payment app 420 may request for the payment while transferring to the payment server 440 the biometric authentication parameter obtained in the biometric authentication procedure of operations 605 to 616. In operation 624, the payment server 440 may transfer the received request to the issuer server 450. In operation 625, the issuer server 450 verifies a signature by using the transferred biometric authentication parameter. If the issuer server 450 fails in signature verification based on biometric authentication, a recovery procedure using password authentication as shown in FIG. 8 described below may be performed to initialize payment and biometric authentication information. If the issuer server 450 succeeds in the signature verification based on biometric authentication, in operations 626 and 627, a response indicating the success may be transferred to the payment app 420 via the payment server 440, thereby performing a final payment. In addition, when the registration state parameter value is ‘false’ to indicate a state where biometric authentication information is not registered, the biometric authentication information may be stored, and the registration state parameter value may be changed to ‘true’ to indicate a state where the biometric authentication information is registered. Herein, the biometric authentication information may be a biometric authentication public key (e.g., cbioPUK) transferred from the payment app 420.

According to various embodiments, if the response of the issuer server 450 in operations 626 and 627 shows that the signature verification based on biometric authentication fails or if the biometric authentication information registration state is different between the issuer server 450 and the payment app 420, or if the user selects to perform the payment using password authentication, the payment may be performed through the password authentication. For the payment through the password authentication, the payment app 420 displays a keypad on a display device (e.g., the display device 160 of FIG. 1) in operation 617, requests the payment server 440 for a number filter key in operation 618, and receives the number filter key from the payment server 440 in operation 619. The payment app 420 may receive a password from the user in operation 620, and may request for encryption while transferring an issuer server public key (e.g., sPUK) and the input password to the authentication module 433 in operation 621. In operation 622, the payment app 420 may receive an encrypted text from the authentication module 433.

According to various embodiments, in operation 623, the payment app 420 may request for the payment while transferring the received encrypted text to the payment server 440. In operation 624, the payment server 440 may transfer the received request to the issuer server 450. In operation 625, the issuer server 450 may use the transferred encrypted text to perform user authentication. If the issuer server 450 fails in authentication based on the encrypted text, the payment is not performed, and a password authentication procedure may be performed again. If the issuer server 450 succeeds in the authentication based on the encrypted text, the payment is performed. After the payment is complete, biometric authentication information may be initialized so that the biometric authentication information storage/registration state of the electronic device 101 and the issuer server 450 is changed to an unstored/unregistered state.

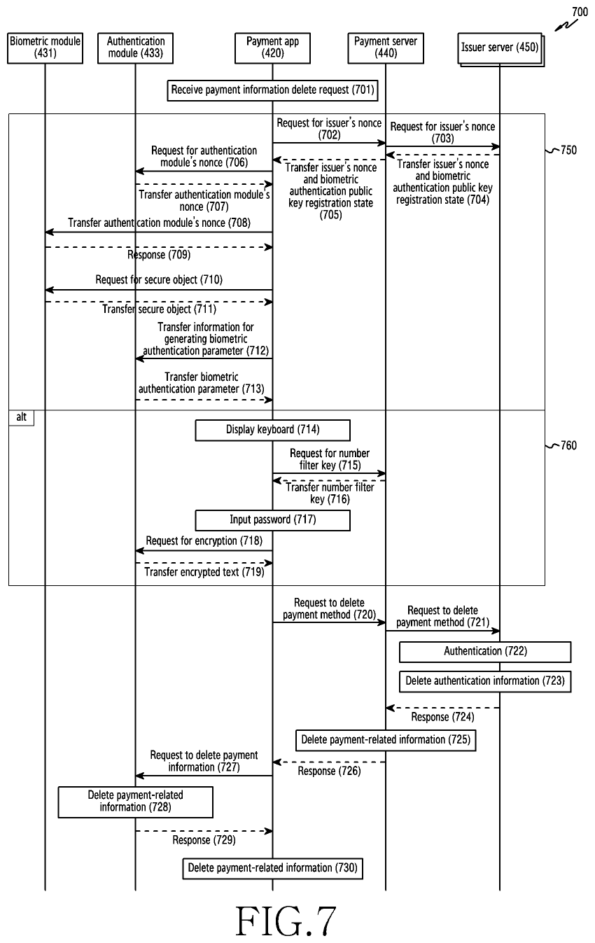

FIG. 7 is a flowchart 700 illustrating a procedure of deleting payment-related information and user authentication information according to various embodiments.

According to various embodiments, in the procedure of deleting the payment information and the user authentication information, a biometric authentication process 750 or a password authentication process 760 may be used to perform user authentication. Alternatively, the biometric authentication process 750 may be used to perform the user authentication, and thereafter if verification on the authentication fails, the password authentication process 760 may be used to perform the user authentication.

Referring to FIG. 7, in operation 701, the payment app 420 may receive a payment information delete request from a user. At the payment information delete request, not only payment information but also related information including user authentication information may be deleted.

According to various embodiments, in operation 702, the payment app 420 may request the issuer server 450 for an original biometric verification value. In operation 703, the payment server 440 may transfer this request to the issuer server 450. In operation 704, the issuer server 450 may generate the original biometric verification value and transfer to the payment server 440 the generated original biometric verification value and a registration state parameter indicating whether there is a biometric authentication public key for user authentication. In operation 705, the payment server 440 may transfer to the payment app 420 the transferred original biometric verification value and registration state parameter.

According to various embodiments, not only when a payment is made but also when the payment information is deleted, a procedure to be performed by the payment app 420 may vary depending on the registration state parameter value and a state where the biometric authentication information is stored in the electronic device 101 in which the payment app 420 is executed. In an embodiment, when in a state where the biometric authentication information is stored in the electronic device 101 and when a registration state parameter value indicates ‘false’, or when in a state where the biometric authentication information is not stored in the electronic device 101 and the registration state parameter value indicates ‘true’ so that the registration state of the biometric authentication information is different between the electronic device 101 and the issuer server 450, user authentication using password authentication may be used to delete the payment information.

In an embodiment, when in a normal state where the biometric authentication information is stored and the registration state parameter value is ‘true’, the electronic device 101 may perform the payment according to a procedure of FIG. 7 described below. In an embodiment, when the biometric authentication information is in an unstored state and the registration state parameter value is ‘false’, the electronic device 101 may delete the payment information according to the procedure of FIG. 7 descried below.

According to various embodiments, if the payment app 420 determines that the biometric authentication information registration state is identical between the electronic device 101 and the issuer server 450 (irrespective of whether it is a registered state or unregistered state), in operation 706, the payment app 420 may request the authentication module 433 for an object reference value. In operation 707, the authentication module 433 may generate the object reference value and transfer it to the payment app 420. In operation 708, the payment app 420 may transfer to the biometric module 431 the object reference value transferred from the authentication module 433. In operation 709, the biometric module 431 may transfer to the payment app 420 a response indicating that the object reference value is received. In addition, in operation 710, the payment app 420 may request the biometric module 431 for a secure object. In operation 711, when the biometric authentication information is in the unstored state, the biometric module 431 may obtain and store biometric information, and when the biometric authentication information is in the stored state, biometric authentication may be performed by comparing the stored biometric information with biometric information obtained from the user. According to a result thereof, an encrypted secure object may be transferred to the payment app 420 so that only the authentication module 433 can decode the object reference value.

According to various embodiments, in operation 712, for biometric authentication, the payment app 420 may transfer information for generating a biometric authentication parameter to the authentication module 433. The transferred information may include the secure object received from the authentication module 433, original data including the original biometric verification value transferred from the issuer server 450 and an app signature hash value for identifying forgery and falsification of an app, and a public key of the issuer server 450. The app signature hash value may be an app IDentification (ID) capable of recognizing the app.

According to various embodiments, the authentication module 433 may generate a biometric authentication private key/public key pair when biometric authentication information is in the unstored state, that is, when there is no biometric authentication private key/public key pair previously generated. When in a state where the biometric authentication information is registered, a private key/public key previously stored may be directly used without having to generate a new biometric authentication private key/public key pair. The authentication module 433 may verify whether the object reference value extracted by decoding the secure object is identical to the object reference value transferred to the payment app 420 in operation 707 to identify whether biometric registration or authentication is achieved. After the verification of the object reference value is complete, the authentication module 433 may generate ‘signed original data’ as a first parameter in which original data is signed with a biometric authentication private key and ‘encrypted original data’ as a second parameter in which the original data is encrypted with a public key (e.g., sPUK) provided by the issuer server 450. In operation 713, three parameters including the first parameter, the second parameter, and a third parameter which is a biometric authentication public key (e.g., cbioPUK) to be used in the issuer server 450 to verify biometric authentication may be transferred to the payment app 420 as the parameter for biometric authentication verification.

According to various embodiments, in operation 720, the payment app 420 may request to delete payment information while transferring to the payment server 440 the biometric authentication parameter obtained in the biometric authentication procedure of operations 702 to 713. In operation 721, the payment server 440 may transfer the received request to the issuer server 450. In operation 722, the issuer server 450 verifies a signature by using the transferred biometric authentication parameter. If the issuer server 450 fails in signature verification based on biometric authentication, a recovery procedure using password authentication as shown in FIG. 8 described below may be performed to initialize payment and biometric authentication information. If the issuer server 450 succeeds in the signature verification based on biometric authentication, when the registration state parameter value is ‘false’ to indicate a state where biometric authentication information is not registered, the biometric authentication information may be stored, and the registration state parameter value may be changed to ‘true’ to indicate a state where the biometric authentication information is registered. In addition, the biometric authentication information may be deleted in operation 723. The biometric authentication information may include a biometric authentication public key (e.g., cbioPUK), and the registration state parameter value may be set to ‘false’.

According to various embodiments, in operation 724, the issuer server 450 may transfer to the payment server 440 a response indicating that authentication is successful. In operation 725, the payment server 450 may receive an authentication success response and delete payment information in operation 725. In operation 726, the issuer server 450 may transfer the authentication success response to the payment app 420. In operation 727, the payment app 420 may transfer to the payment module 433 a request for deleting payment information in response to the authentication success. In operation 728, the payment module 433 may delete payment-related information including a biometric authentication private key (e.g., cbioPRV) and public key (e.g., cbioPUK). In operation 729, the payment module 433 may transfer to the payment app 4220 a response indicating a successful deletion. In operation 730, the payment app 420 may delete the payment-related information, and may delete a public key (e.g., sPUK) of the related issuer server 450.

According to various embodiments, if the response of the issuer server 450 in operations 724 and 726 shows that the signature verification based on biometric authentication fails or if the biometric authentication information registration state is different between the issuer server 450 and the payment app 420, or if the user selects to perform the payment using password authentication, payment information may be deleted through the password authentication. To delete the payment information through the password authentication, the payment app 420 displays a keypad on a display device (e.g., the display device 160 of FIG. 1) in operation 714, requests the payment server 440 for a number filter key in operation 715, and receives the number filter key from the payment server 440 in operation 716. The payment app 420 receives a password from the user in operation 717, and requests for encryption while transferring an issuer server public key (e.g., sPUK) and the input password to the authentication module 433 in operation 718. In operation 719, the payment app 420 may receive an encrypted text from the authentication module 433.

According to various embodiments, in operation 720, the payment app 420 may request to delete the payment information while transferring the received encrypted text to the payment server 440. In operation 721, the payment server 440 may transfer the received request to the issuer server 450. In operation 722, the issuer server 450 may use the transferred encrypted text to perform user authentication. If the issuer server 450 fails in authentication based on the encrypted text, the payment is not performed, and a password authentication procedure may be performed again. If the issuer server 450 succeeds in the authentication based on the encrypted text, the payment-related information may be deleted according to operations 723 to 730.

According to various embodiments, if the registration state of the biometric authentication information is different between the payment app 420 and the issuer server 450 or if verification based on biometric authentication fails when the payment is made using biometric authentication, user authentication using password authentication may be used to perform the payment. After the payment is complete, the registration state parameter value may be set to ‘false’, and biometric authentication of the payment app 420 may be set to the unstored state, thereby performing a recovery procedure through password authentication to match the both states.

FIG. 8 is a flowchart 800 illustrating a recovery procedure through password authentication depending on a failure in verification based on biometric authentication according to various embodiments.

Referring to FIG. 8, in operation 801, the payment app 420 may receive a payment request from an Internet store payment app 860.

According to various embodiments, in operation 802, the payment app 420 may request the issuer server 450 for an original biometric verification value. In operation 803, the payment server 440 may transfer this request to the issuer server 450. In operation 804, the issuer server 450 may generate the original biometric verification value and transfer to the payment server 440 the generated original biometric verification value and a registration state parameter indicating whether there is a biometric authentication public key for user authentication. In operation 805, the payment server 440 may transfer to the payment app 420 the transferred original biometric verification value and registration state parameter.

According to various embodiments, in operation 806, the payment app 420 may perform biometric authentication. The payment app 420 may generate a biometric authentication parameter by performing biometric authentication according to the procedure based on operations 509 to 516 of FIG. 5, operations 609 to 616 of FIG. 6, or operations 706 to 713 of FIG. 7.

According to various embodiments, in operation 807, the payment app 420 may request for a payment while transferring to the payment server 440 the biometric authentication parameter generated in the biometric authentication procedure. In operation 808, the payment server 440 may transfer the received request to the issuer server 450. In operation 809, the issuer server 450 verifies a signature by using the transferred biometric authentication parameter. Herein, the signature verification may fail. If the signature verification fails, a recovery procedure using password authentication may be performed to initialize payment and biometric authentication information.

According to various embodiments, if the issuer server 450 fails in the signature verification based on biometric authentication, in operations 810 and 811, the issuer server 450 may transfer to the payment server 440 a response indicating that the signature verification fails, and the payment server 440 may transfer it to the payment app 420.

According to various embodiments, the payment app 420 may perform the payment through password authentication upon receiving the response indicating that the signature verification based on biometric authentication fails. In operation 812, the payment app 420 may perform password authentication. The password authentication may be performed based on operations 517 to 522 of FIG. 5, or operations 617 to 622 of FIG. 6, or operations 714 to 719 of FIG. 7, and an encrypted text in which a password is encrypted may be generated.

According to various embodiments, in operation 813, the payment app 420 may request for the payment while transferring the encrypted text to the payment server 440. In operation 814, the payment server 440 may transfer the received request to the issuer server 450. In operation 815, the issuer server 450 may perform user authentication by using the transferred encrypted text, and may complete the payment upon succeeding in password authentication. In operations 816 and 817, the issuer server 450 may transfer a response indicating a payment success to the payment server 440, and the payment server 440 may transfer a payment success response to the payment app 420.

According to various embodiments, the payment app 420 may change a biometric authentication information storage state thereof to an unstored state. In operation 818, the payment app 420 may transfer to the payment server 440 a request for changing a biometric authentication information registration state of the issuer server 450 to an unregistered state. The request for changing the biometric authentication information registration state to the unregistered state may be a request for deleting a biometric authentication public key of the payment app 420 registered with the issuer server 450. In operation 819, the payment server 440 may transfer the change request to the issuer server 450. In operation 820, upon receiving the change request, the issuer server 450 may delete the biometric authentication public key corresponding to the payment app 420, and may change a registration state parameter indicating whether the biometric authentication public key is registered to a value corresponding to ‘false’. In operation 821, the issuer server 450 may transfer to the payment server 440 a response indicating that the change is complete. In operation 822, the payment server 440 may transfer a change complete response to the payment app 420. In operation 823, upon receiving the change complete response, the payment app 420 may transfer to the payment app 860 of the Internet store a response indicating that the payment is complete.

A payment method using biometric authentication has been described above in terms of the entire system. Hereinafter, the payment method using biometric authentication will be described in terms of the electronic device 101.

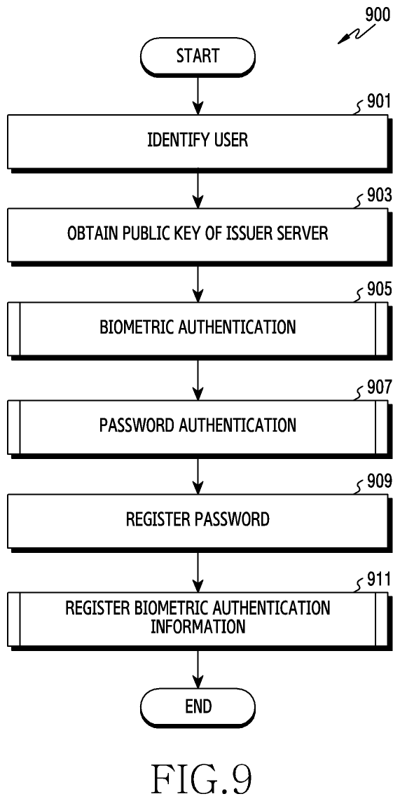

FIG. 9 is a flowchart 900 illustrating an operation of the electronic device 101 for registering payment information and user authentication information according to various embodiments. It may be understood that an operating entity of the flowchart 900 of FIG. 9 is an electronic device (e.g., the electronic device 101 of FIG. 1) or a component of the electronic device 101 (e.g., the processor 120 of FIG. 1, the payment app 420, biometric module 431, and/or authentication module 433 of FIG. 4).

According to various embodiments, in operation 901, the electronic device 101 may identify a legitimate user for payment information such as a card to be used, a phone-based micropayment, or the like. The electronic device 101 may transfer user information and payment-related information such as card information, micropayment information, or the like to the issuer server 450 through the payment server 440, and may receive an approval response from the issuer server 450 to identify the user.

According to various embodiments, in operation 903, the electronic device 101 may obtain a public key (e.g., sPUK) of the issuer server 450. The public key of the issuer server 450 may be transferred from the issuer server 450 to the payment server 440. According to an embodiment, for security, the public key may be transferred offline from the issuer server 450 to the payment server 440. When the payment information and the user authentication information are registered, the electronic device 101 may request the payment server 440 for the public key of the issuer server 450 to receive the public key, and may store the transferred public key of the issuer server 450 in a memory (e.g., the memory 130 of FIG. 1). The public key of the issuer server 450 may be used to encrypt a message transferred to the issuer server 450.

According to various embodiments, in operation 905, the electronic device 101 may perform biometric authentication. The electronic device 101 may have a parameter stored therein to indicate a storage state of biometric authentication information. In addition, the electronic device 101 may receive a registration state parameter indicating a registration state of biometric authentication information related thereto from the issuer server 450 and determine whether the biometric authentication information related thereto is registered with the issuer server. When registered for the first time, the storage state of the biometric authentication information and the registration state of the biometric authentication information of the issuer server 450 may be an unstored/unregistered state (a parameter corresponds to a value corresponding to ‘false’).

According to various embodiments, the electronic device 101 may generate a parameter for biometric authentication verification to be transmitted to the issuer server 450 through a biometric authentication process. The parameter for biometric authentication verification may include ‘signed original data’ as a first parameter in which original data is signed with a biometric authentication private key (e.g., cbioPRV), ‘encrypted original data’ as a second parameter in which the original data is encrypted with a public key (e.g., sPUK) provided by the issuer server 450, and a biometric authentication public key (e.g., cbioPUK) as a third parameter. Herein, the original data may include an original biometric verification value received from the issuer server 450, a secure object encrypted from an object reference value generated from the biometric module 431, and an app signature hash value for identifying forgery and falsification of an app.

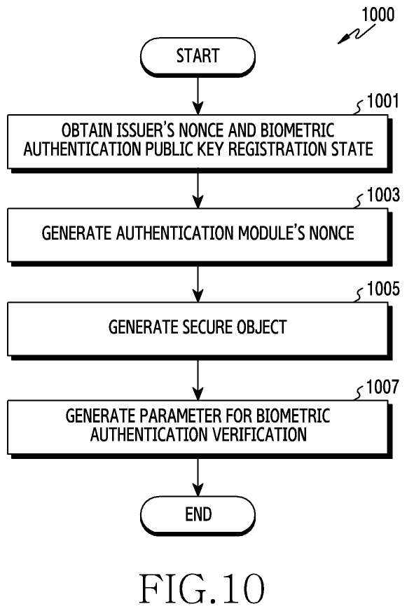

According to various embodiments, the electronic device 101 may perform biometric authentication based on operations 505 to 516 of FIG. 5, operations 605 to 616 of FIG. 6, operations 703 to 713 of FIG. 7, or operations of FIG. 10 described below.

According to various embodiments, in operation 907, the electronic device 101 may perform password authentication. The electronic device 101 may register a password, which is to be used for user authentication when a payment is made, with the issuer server 450. The electronic device 101 may receive a password, which is to be registered through the password authentication, input from the user, and may encrypt the input password by using a public key (e.g., sPUK) of the issuer server 450.

According to various embodiments, the electronic device 101 may operate based on operations 517 to 522 of FIG. 5, or operations 617 to 622 of FIG. 6, or operations 714 to 719 of FIG. 7, and an encrypted text in which a password is encrypted may be generated.

According to various embodiments, in operation 909, the electronic device 101 may transfer to the issuer server 450 the encrypted text generated through password authentication, thereby registering the password.

According to various embodiments, in operation 911, the electronic device 101 may transfer to the issuer server 450 a parameter generated in operation 905 for biometric authentication verification, and thus may store biometric authentication information in the issuer server 450. The biometric authentication information may be a biometric authentication public key (e.g., cbioPUK) of the electronic device 101. The issuer server 450 may receive the parameter for biometric authentication verification, and perform authentication by using the received parameter. If the authentication is successful, the issuer server 450 may store the received biometric authentication information of the electronic device 101.

According to various embodiments, if a registration success response of the biometric authentication information is not received from the issuer server 450 within a specific period of time, the electronic device 101 may register the biometric authentication information by performing operations 905 to 911 again. If the registration success response of the biometric authentication information is received from the issuer server 450 within the specific period of time, the electronic device 101 may determine that payment information registration and user authentication information are normally registered, and may end the registration operation.

FIG. 10 is a flowchart 1000 illustrating an operation of the electronic device 101 for biometric authentication according to various embodiments. The flowchart 1000 of FIG. 10 is an embodiment of the operation 905 of FIG. 9, and it may be understood that an operating entity is an electronic device (e.g., the electronic device 101 of FIG. 1) or a component of the electronic device 101 (e.g., the processor 120 of FIG. 1, the payment app 420, biometric module 431, and/or authentication module 433 of FIG. 4).

According to various embodiments, in operation 1001, the electronic device 101 may request the issuer server 450 for an original biometric verification value, and thus may obtain the original biometric verification value and a biometric authentication information (biometric authentication public key) registration state from the issuer server 450. Information indicating the original biometric verification value and biometric authentication information registration state may be received from the issuer server 450 to the electronic device 101 via the payment server 440.

According to various embodiments, in operation 1003, the authentication module 433 of the electronic device 101 may generate an object reference value, and may transfer it to the biometric module 431. In this case, the object reference value may be generated in the authentication module 433 under the control of the payment app 420, and may be transferred to the biometric module 431 via the payment app 420.

According to various embodiments, in operation 1005, the biometric module 431 of the electronic device 101 may perform biometric authentication, and may generate a secure object based on a result thereof. According to an embodiment, the biometric module 431 may determine that biometric information is authenticated if biometric information previously stored is identical to biometric information input by a user, and may determine that biometric information authentication fails if not identical. If it is determined that the biometric information authentication fails, the biometric module 431 may request the user to input the biometric information again, or may allow an authentication system to switch to password authentication. If it is determined that the biometric information is authenticated, the biometric module 431 may generate an encrypted secure object so that only the authentication module 433 can decode the object reference value received through the payment app 420, and may transfer it to the payment app 420.

According to various embodiments, in operation 1007, for biometric authentication, the electronic device 101 may generate a parameter to be transferred to the issuer server 450. According to an embodiment, the payment app 420 of the electronic device 101 may generate original data including the secure object subjected to biometric authentication and transferred from the biometric module 431, the original biometric verification value transferred from the issuer server 450, and an app signature hash value for identifying forgery and falsification of an app. The authentication module 431 may autonomously generate a biometric authentication public key (e.g., cbioPRV) and a biometric authentication public key (e.g., cbioPUK), and may generate ‘signed original data’ in which original data is signed with a biometric authentication private key (e.g., cbioPRV) and ‘encrypted original data’ in which the original data is encrypted with a public key (e.g., sPUK) provided by the issuer server 450. The biometric authentication private key and public key are not generated every time, but are generated and stored only when a biometric authentication information storage state of the electronic device 101 is an unstored state. Thereafter, the stored biometric authentication private key and public key may be used. A parameter to be transferred to the issuer server 450 for biometric authentication may include the ‘signed original data’, the ‘encrypted original data’, and the biometric authentication public key.

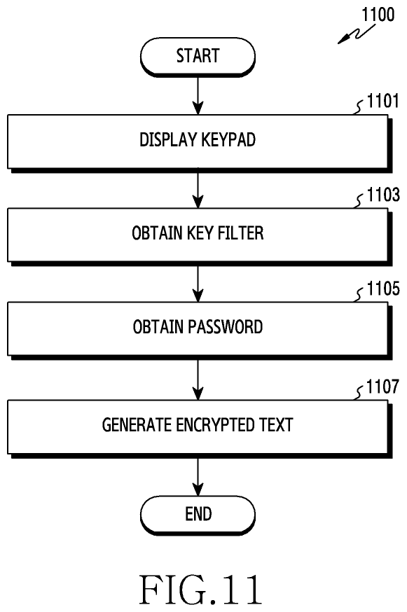

FIG. 11 is a flowchart 1100 illustrating an operation of the electronic device 101 for password authentication according to various embodiments. The flowchart 1100 of FIG. 11 is an embodiment of the operation 907 of FIG. 9, and it may be understood that an operating entity is an electronic device (e.g., the electronic device 101 of FIG. 1) or a component of the electronic device 101 (e.g., the payment app 420 and/or authentication module 433 of FIG. 4).

According to various embodiments, in operation 1101, the electronic device 101 may display a key pad on a display device (e.g., the display device 160 of FIG. 1) so that a user inputs a password.

According to various embodiments, in operation 1103, the electronic device 101 may obtain a key filter from the issuer server 450. Even if the user inputs the same number, it may be modified by the key filter so that the same signal is not transmitted to the issuer server 450.

According to various embodiments, in operation 1105, the electronic device 101 may obtain a password depending on a user input.

According to various embodiments, in operation 1107, the authentication module 433 of the electronic device 101 may generate an encrypted text in which the password input by the user is encrypted with the public key of the issuer server. The generated encrypted text may be transferred to the issuer server 450, based on operation 909, so that the password is registered.

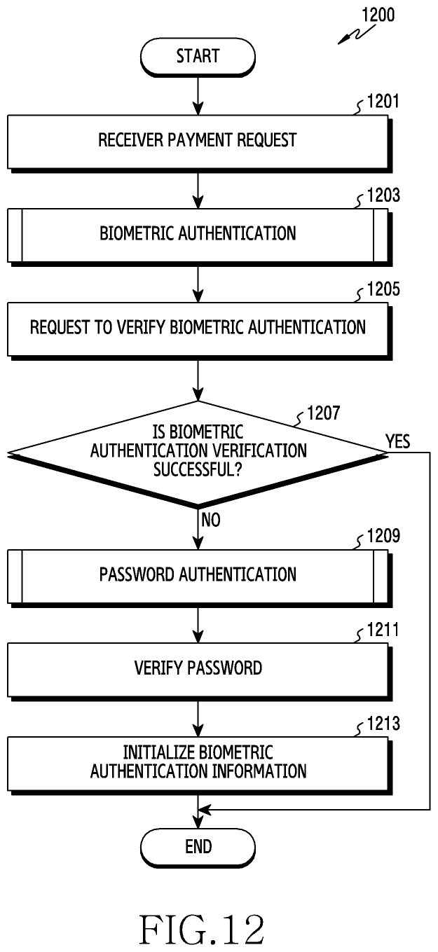

FIG. 12 is a flowchart 1200 illustrating a payment operation of the electronic device 101 according to various embodiments. In the flowchart 1200 of FIG. 12, it may be understood that an operating entity is an electronic device (e.g., the electronic device 101 of FIG. 1) or a component of the electronic device 101 (e.g., the processor 120 of FIG. 1, the payment app 420, biometric module 431, and/or authentication module 433 of FIG. 4).

According to various embodiments, in operation 1201, the payment app 420 of the electronic device 101 may receive a payment request. Upon receiving the payment request, in operation 1203, the electronic device 101 may perform biometric authentication and generate a parameter which is for biometric authentication verification and transferred to the issuer server 450. The electronic device 101 may perform the biometric authentication according to the flowchart of FIG. 10.

According to various embodiments, in operation 1205, the electronic device 101 may request to verify biometric authentication by transmitting the parameter for biometric authentication verification to the issuer server 450. In operation 1207, the electronic device 101 may receive a verification result from the issuer server 450 to determine whether verification is successful. According to an embodiment, if the verification is successful, a payment may be complete and the operation may end. According to an embodiment, if it is determined that the verification fails, in operation 1209, the electronic device 101 may switch to password verification according to the flowchart of FIG. 11 and thus receive a password input from a user and generate an encrypted text in which the password is encrypted.

According to various embodiments, in operation 1211, the electronic device 101 may transfer the encrypted text to the issuer server 450 to verify the password. The issuer server 450 may compare a stored password of the electronic device 101 with the password transferred as the encrypted text, may determine that the password is verified if the passwords are identical and determine that the password is not verified if the passwords are not identified, and may transfer a result thereof to the electronic device 101. If the verification result transferred from the issuer server 450 shows that the password is not verified, the electronic device 101 may perform password authentication again. If it shows that the password is verified, in operation 1213, the electronic device 101 may initialize biometric authentication information, thereby additionally enabling up to a payment approval. However, it is also possible that only the biometric authentication information is initialized without the payment approval, and the biometric authentication information is added while attempting a new payment.

According to various embodiments, in order to initialize the biometric authentication information in operation 1213, the electronic device 101 may change a biometric authentication information storage state stored in a memory thereof (e.g., the memory 130 of FIG. 1) to ‘false’, and may transmit a request message for initializing biometric authentication information to the issuer server 450. The issuer server 450 may receive this request message and may change a registration state parameter indicating a biometric authentication information registration state to ‘false’.

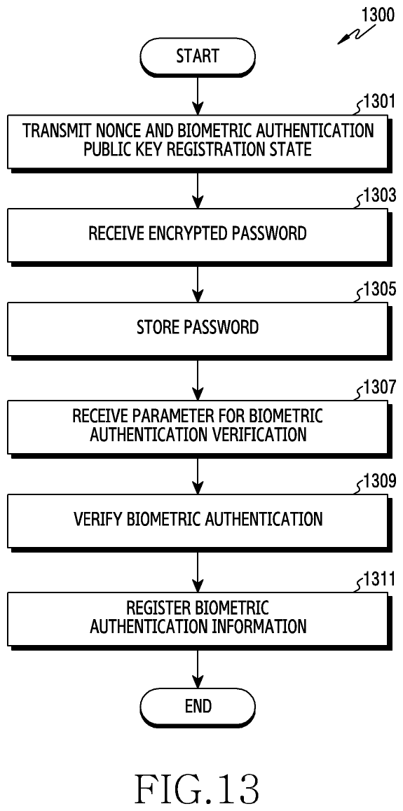

FIG. 13 is a flowchart 1300 illustrating an operation of the issuer server 450 for registering payment information and user authentication information according to various embodiments. In the flowchart 1300 of FIG. 13, it may be understood that an operating entity is an issuer server (e.g., the issuer server 450 of FIG. 4) or a component of the issuer server 450 (e.g., the SBA server 451 of FIG. 4).

According to various embodiments, in operation 1301, in order to register user authentication information, the issuer server 450 may transmit an original biometric verification value generated at the request from the electronic device 101 and a corresponding biometric authentication information registration state of the electronic device 101. The biometric authentication information registration state may be represented by a registration state parameter. The registration state parameter may have a value corresponding to ‘true’ or a value corresponding to ‘false’. If it is ‘true’, it may indicate that the biometric authentication information is in a registered state, and if it is ‘false’, it may indicate that the biometric authentication information is in an unregistered state. In case of first-time registration, the registration state parameter may have a value corresponding to ‘false’.

According to various embodiments, in operation 1303, the issuer server 450 may receive from the electronic device 101 an encrypted text including a password encrypted with a public key thereof (e.g., sPUK). In operation 1305, the issuer server 450 may use a private key thereof (e.g., sPRV) to obtain a password from the encrypted text and store the password.

According to various embodiments, in operation 1307, the issuer server 450 receives a parameter for biometric authentication verification from the electronic device 101. The parameter for biometric authentication verification may include ‘signed original data’ as a first parameter in which original data is signed with a biometric authentication private key (e.g., cbioPRV) of the electronic device 101, ‘encrypted original data’ as a second parameter in which the original data is encrypted with a public key (e.g., sPUK) provided by the issuer server 450, and a biometric authentication public key (e.g., cbioPUK) as a third parameter. Herein, the original data may include the original biometric verification value received from the issuer server 450, a secure object encrypted from an object reference value generated from the biometric module 431, and an app signature hash value for identifying forgery and falsification of an app.

According to various embodiments, in operation 1309, the issuer server 450 verifies biometric authentication by using the transferred parameter. When the biometric authentication is verified, biometric authentication information may be registered in operation 1311. The biometric authentication information may be a corresponding biometric authentication public key (e.g., cbioPUK) of the electronic device 101. When registration of the biometric authentication information is complete, the registration operation may be complete.

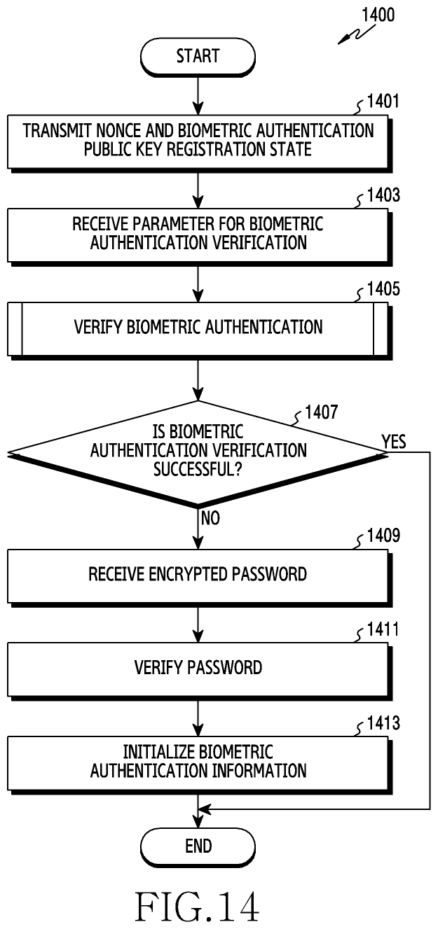

FIG. 14 is a flowchart 1400 illustrating an operation of the issuer server 450 when a payment is made, according to various embodiments. It may be understood that an operating entity of the flowchart 1400 of FIG. 14 is an issuer server (e.g., the issuer server 450 of FIG. 4) or a component of the issuer server 450 (e.g., the SBA server 451 of FIG. 4).

According to various embodiments, in operation 1401, in order to perform the payment, the issuer server 450 may transmit an original biometric verification value generated at the request from the electronic device 101 and a corresponding biometric authentication information registration state of the electronic device 101. The biometric authentication information registration state may be represented by a registration state parameter. The registration state parameter may have a value corresponding to ‘true’ or a value corresponding to ‘false’. If it is ‘true’, it may indicate that the biometric authentication information is in a registered state, and if it is ‘false’, it may indicate that the biometric authentication information is in an unregistered state. When in a normal state where the registration of biometric authentication information is complete, the registration state parameter may have a value corresponding to ‘true’.

According to various embodiments, in operation 1403, the issuer server 450 may receive a parameter for biometric authentication verification from the electronic device 101. The parameter for biometric authentication verification may include ‘signed original data’ as a first parameter in which original data is signed with a biometric authentication private key (e.g., cbioPRV) of the electronic device 101, ‘encrypted original data’ as a second parameter in which the original data is encrypted with a public key (e.g., sPUK) provided by the issuer server 450, and a biometric authentication public key (e.g., cbioPUK) as a third parameter. Herein, the original data may include the original biometric verification value received from the issuer server 450, a secure object encrypted from an object reference value generated from the biometric module 431, and an app signature hash value for identifying forgery and falsification of an app.

According to various embodiments, in operation 1405, the issuer server 450 verifies biometric authentication by using the transferred parameter. In order to verify biometric authentication, the issuer server 450 may decode ‘encrypted original data’ with s private key thereof to verify an app hash value and the original biometric verification value, may compare a biometric authentication public key received as a third parameter with a corresponding stored biometric authentication public key of the electronic device 101 to identify whether they are identical, and may verify a signature of ‘signed original data’ by using the biometric authentication public key to verify the biometric authentication.

According to various embodiments, in operation 1407, the issuer server 450 may transfer to the electronic device 101 a biometric authentication verification result received from the electronic device 101. The issuer server 450 may approve and complete the payment if the biometric authentication verification is successful, and may wait to receive an encrypted password from the electronic device if the biometric authentication verification fails.

According to various embodiments, in operation 1409, the issuer server 450 may receive the encrypted password from the electronic device 101 if the biometric authentication verification fails. In operation 1411, the issuer server 450 may decode the received encrypted password by using a private key of the issuer server 450 to obtain a password, and may verify the password by comparing it with a corresponding stored password of the electronic device 101. Upon completion of the password verification, the payment approval may be transferred to the electronic device 101 to complete the payment.

According to various embodiments, in operation 1413, a request message for initializing biometric authentication information may be received from the electronic device 101. A registration state parameter indicating a biometric authentication information registration state may be changed to a value corresponding to ‘false’ which means the unregistered state. A corresponding stored biometric authentication public key (e.g., cbioPUK) of the electronic device 101 may be deleted.

According to various embodiments, if the biometric authentication verification fails during the payment as described above, the electronic device 101 and the issuer server 450 may initialize the biometric authentication information storage/registration state to an unstored/unregistered state in accordance with a recovery procedure through password authentication based on operations 1409 to 1413. In a state where registration for use is achieved and a password is registered, if biometric authentication fails and thus the biometric authentication information storage/registration state of the electronic device 101 and issuer server 450 is initialized to the unstored/unregistered state, according to the method proposed in the disclosure, the payment may be performed while registering the biometric authentication information with the issuer server 450.

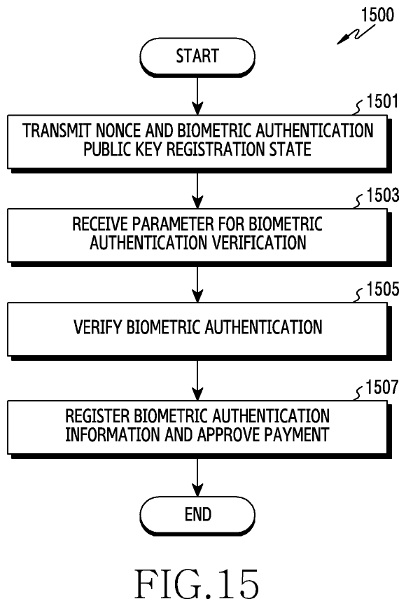

FIG. 15 is a flowchart 1500 illustrating an operation of the issuer server 450 when a payment is made after biometric authentication information is initialized by a recovery procedure according to various embodiments. It may be understood that an operating entity of the flowchart 1500 of FIG. 15 is an issuer server (e.g., the issuer server 450 of FIG. 4) or a component of the issuer server 450 (e.g., the SBA server 451 of FIG. 4).

According to various embodiments, in operation 1501, in order to perform the payment, the issuer server 450 may transmit an original biometric verification value generated at the request from the electronic device 101 and a corresponding biometric authentication information registration state of the electronic device 101. The biometric authentication information registration state may be represented by a registration state parameter. In case of the embodiment, the registration state parameter may have a value corresponding to ‘false’ which means that the biometric authentication information registration state is an unregistered state. Herein, the biometric authentication information may be a biometric authentication public key transferred by the electronic device 101 to the issuer server 450.

According to various embodiments, in operation 1503, the issuer server 450 may receive a parameter for biometric authentication verification from the electronic device 101. The parameter for biometric authentication verification may include ‘signed original data’ as a first parameter in which original data is signed with a biometric authentication private key (e.g., cbioPRV) of the electronic device 101, ‘encrypted original data’ as a second parameter in which the original data is encrypted with a public key (e.g., sPUK) provided by the issuer server 450, and a biometric authentication public key (e.g., cbioPUK) as a third parameter. Herein, the original data may include the original biometric verification value received from the issuer server 450, a secure object encrypted from an object reference value generated from the biometric module 431, and an app signature hash value for identifying forgery and falsification of an app.

According to various embodiments, in operation 1505, the issuer server 450 verifies biometric authentication by using the transferred parameter. In order to verify biometric authentication, the issuer server 450 may decode ‘encrypted original data’ with a private key thereof to verify an app hash value and the original biometric verification value, and may verify a signature of ‘signed original data’ by using a biometric authentication public key received as a third parameter to verify the biometric authentication. Upon verifying the biometric authentication, the biometric authentication information may be registered while approving the payment to complete the payment.

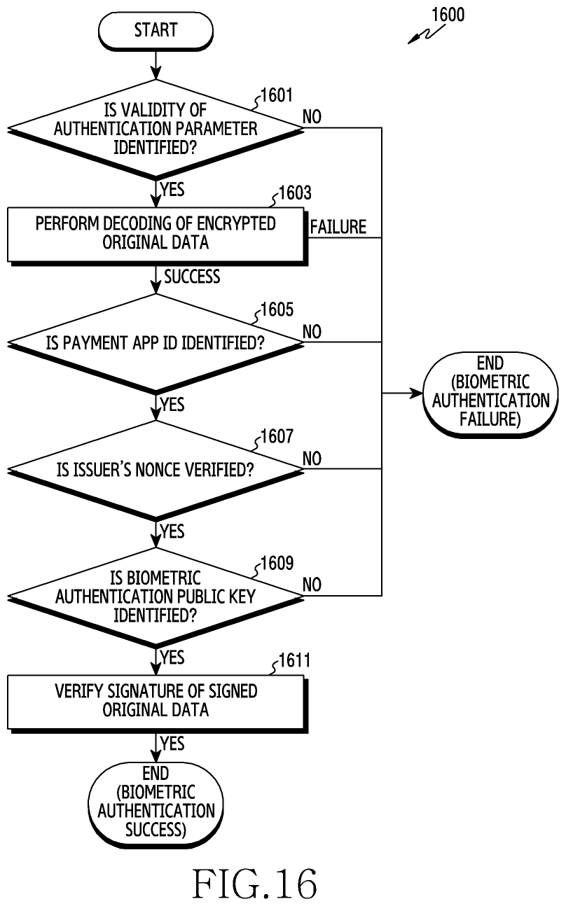

FIG. 16 is a flowchart 1600 illustrating an operation of the issuer server 450 for biometric authentication verification according to various embodiments. It may be understood that an operating entity of the flowchart 1600 of FIG. 16 is an issuer server (e.g., the issuer server 450 of FIG. 4) or a component of the issuer server 450 (e.g., the SBA server 451 of FIG. 4).

According to various embodiments, in operation 1601, the issuer server 450 may identify validity of a parameter for biometric verification, received from the electronic device 101. The validity of the parameter may identify the validity by verifying a length or type field defined on a standard in the parameter for biometric authentication verification. If the validity is not identified, it may be determined that biometric authentication verification has failed.

According to various embodiments, in operation 1603, the issuer server 450 may decode ‘encrypted original data’ with a public key thereof to obtain ‘original data’. If it fails to obtain the original data, it may be determined that biometric authentication verification has failed.

According to various embodiments, in operation 1605, the issuer server 450 may verify whether an app signature hash value included in the original data is a value corresponding to a legitimate app. If it fails in the verification, it may be determined that biometric authentication verification has failed.

According to various embodiments, in operation 1607, the issuer server 450 may compare an original biometric verification value included in the original data with an original biometric verification value transmitted to the electronic device 101 at the request of the electronic device 101 when the payment starts to determine whether the values are identical, and may verify whether a specific pre-set period of time elapses after the original biometric verification value is issued. It may be determined that the biometric authentication verification has failed, if the original biometric verification value included in the original data and the original biometric verification value issued with the electronic device 101 are not identical or if a specific period of time elapses after the original biometric verification value issued.

According to various embodiments, in operation 1609, the issuer server 450 may determine whether a biometric authentication public key received from the electronic device 101 is identical to a corresponding pre-registered biometric authentication public key of the electronic device 101. If the registration state parameter has a value corresponding to ‘false’ which means a state where the biometric authentication information is not registered, the operation 1609 of determining whether the biometric authentication public keys are identical may not be performed. If the registration state parameter has a value corresponding to ‘true’ and if the biometric authentication public key received from the electronic device 101 is not identical to the pre-registered biometric authentication public key corresponding to the electronic device 101, it may be determined that the biometric authentication verification has failed.

According to various embodiments, in operation 1611, the issuer server 450 may verify a signature of ‘signed original data’ by using the biometric authentication public key received from the electronic device 101 or the pre-registered biometric authentication public key. The signature may obtain original data from the ‘signed original data’ by using the biometric authentication public key, and may perform verification by comparing the original data with original data obtained from the aforementioned ‘encrypted original data’. The issuer server 450 may determine that biometric authentication verification fails if signature verification fails, and may determine that the biometric authentication verification is successful if the signal verification is successful.

The aforementioned content may be summarized as follows.

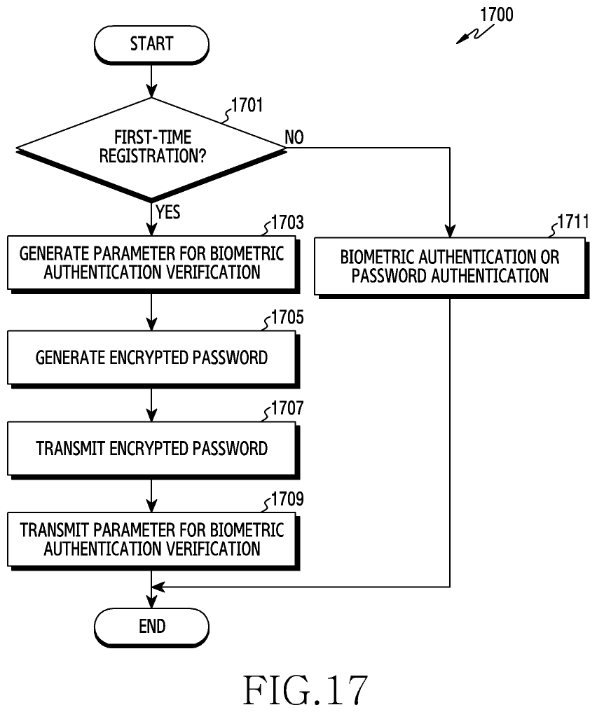

FIG. 17 is a flowchart 1700 briefly illustrating an operation of the electronic device 101 for user authentication according to various embodiments.

Referring to FIG. 17, in operation 1701, the electronic device 101 may determine whether it is registered for a first time use. It may be determined according to an input of a user, or may be determined based on information stored in the electronic device 101.

According to various embodiments, in case of first-time registration, in operation 1703, the electronic device 101 may generate a parameter for biometric authentication verification. In operation 1705, the electronic device 101 may generate an encrypted password in which a password input by the user is encrypted, so as to be used as user authentication. In order to register user authentication through biometric authentication and password authentication with the issuer server 450, the electronic device 101 may transmit the encrypted password to the issuer server 450 in operation 1707, and may transmit the parameter for biometric authentication verification to the issuer server 450 in operation 1709. The issuer server 450 may store biometric authentication information and a password for user authentication, based on the parameter for biometric authentication verification and the encrypted password.

According to various embodiments, in operation 1711, after the first-time registration is complete, the electronic device 101 may perform user authentication for a payment by using biometric authentication or password authentication. In particular, when there is a need to change biometric authentication information registered with the issuer server 450, new biometric authentication information may be registered with the issuer server 450 together in the process of performing the payment in operation 1711.

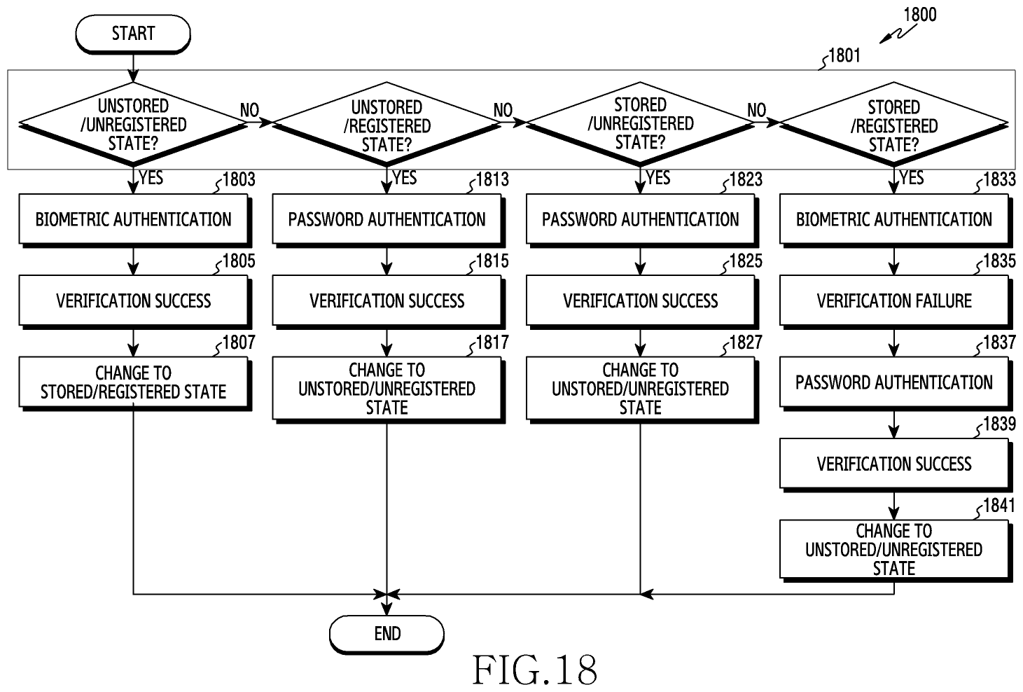

FIG. 18 is a flowchart 1800 illustrating an authentication procedure of the electronic device 101 when a payment is made depending on a biometric authentication information storage state of the electronic device 101 and a biometric authentication information registration state of the issuer server 450 according to various embodiments. The flowchart 1800 of FIG. 18 is an embodiment of the operation 905 of FIG. 9, and it may be understood that an operating entity is an electronic device (e.g., the electronic device 101 of FIG. 1) or a component of the electronic device 101 (e.g., the processor 120 of FIG. 1, the payment app 420, biometric module 431, and/or authentication module 433 of FIG. 4).

Referring to FIG. 18, a biometric authentication information storage state of the electronic device 101 and a biometric authentication information registration state of the issuer server 450 may include four states. According to these states of the electronic device 101, whether to use biometric authentication or password authentication for user authentication may be determined.

According to various embodiments, when the biometric authentication information storage state of the electronic device 101 and the biometric authentication information registration state of the issuer server 450 are an unstored/unregistered state, in operation 1803, the electronic device 101 may use biometric authentication for the payment. In operation 1805, if verification is successful by the issuer server 450, the payment may be approved, and the biometric authentication information storage state and the biometric authentication information registration state of the issuer server 450 may be changed to a stored/registered state. In this case, the issuer server 450 may register a biometric authentication public key received from the electronic device 101 for biometric authentication verification as biometric authentication information.

According to various embodiments, when the biometric authentication information storage state of the electronic device 101 and the biometric authentication information registration state of the issuer server 450 are the unstored/registered state, in operation 1813, the electronic device 101 may use password authentication for the payment. In operation 1815, if verification performed by the issuer server 450 is successful, the payment is approved, and the biometric authentication information storage state and the biometric authentication information registration state of the issuer server 450 may be initialized to the unstored/unregistered state. At a next payment, new biometric authentication information may be stored in the issuer server 450 when the payment is performed according to the aforementioned operations 1803 to 1807.

According to various embodiments, when the biometric authentication information storage state of the electronic device 101 and the biometric authentication information registration state of the issuer server 450 are the stored/unregistered state, in operation 1823, the electronic device 101 may use password authentication for the payment. In operation 1825, if verification performed by the issuer server 450 is successful, the payment is approved, and the biometric authentication information storage state and the biometric authentication information registration state of the issuer server 450 may be initialized to the unstored/unregistered statues. At a next payment, new biometric authentication information may be stored in the issuer server 450 when the payment is performed according to the aforementioned operations 1803 to 1807.

According to various embodiments, when the biometric authentication information storage state of the electronic device 101 and the biometric authentication information registration state of the issuer server 450 are the stored/registered state, in operation 1833, the electronic device 101 may use biometric authentication for the payment. If verification performed by the issuer server 450 fails in operation 1835, the electronic device 101 switches to password authentication in operation 1837. If the verification performed by the issuer server 450 is successful in operation 1839, the payment may be approved, and the biometric authentication information storage state and the biometric authentication information registration state of the issuer server 450 may be initialized to the unstored/unregistered state. At a next payment, new biometric authentication information may be stored in the issuer server 450 when the payment is performed according to the aforementioned operations 1803 to 1807. However, if the verification performed by the issuer server 450 is successful in operation 1835, the payment is approved, and the biometric authentication information storage state and the biometric authentication information registration state of the issuer server 450 remain in the stored/registered state without alteration.

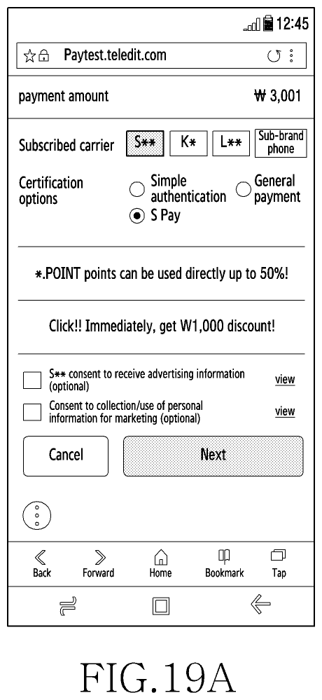

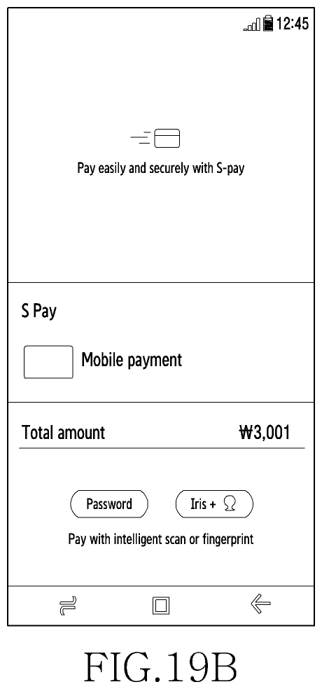

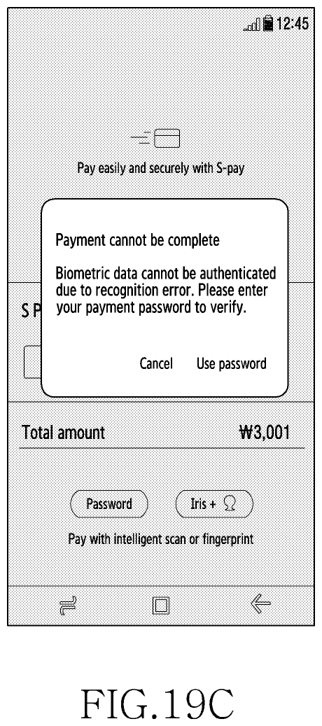

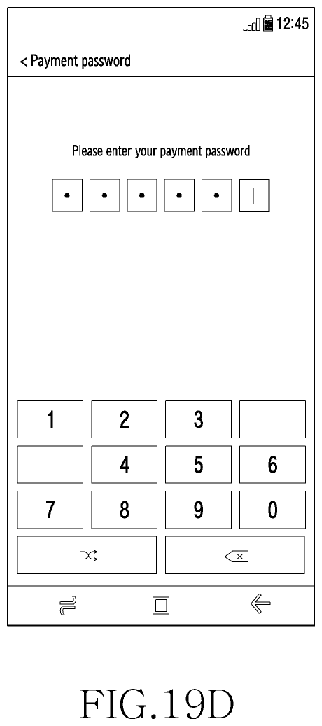

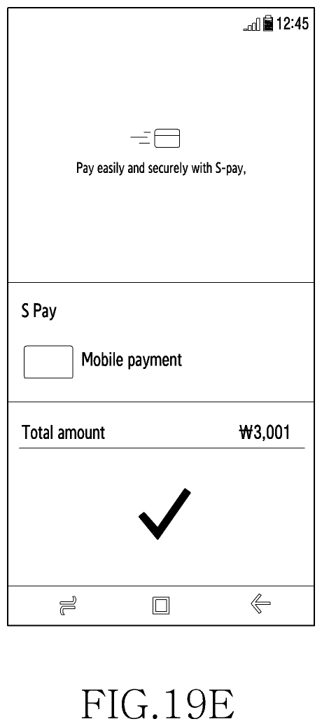

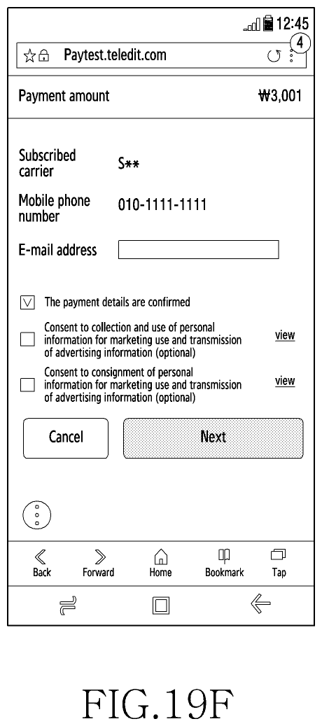

FIG. 19A to FIG. 19F illustrate an example displayed on a display device when a recovery procedure is performed through password authentication due to a failure in biometric authentication verification when a payment is made based on FIG. 14 according to various embodiments.

FIG. 19A illustrates an example of the payment app 860 of an Internet store. A user may select to use the payment app 420 (e.g., Samsung pay) proposed in the disclosure from the payment app 860 of the Internet store. Then, the payment app 420 of the electronic device 101 attempts a biometric authentication payment. It is shown in FIG. 19B that the biometric authentication payment is attempted. Upon receiving from the issuer server 450 a result that the biometric authentication verification has failed, as shown in FIG. 19C, the electronic device 101 may indicate that biometric data cannot be authenticated, and may inform that a password-based payment is to be attempted. When the user selects to attempt password authentication, the electronic device 101 switches to a password authentication payment, and as shown in FIG. 19D, displays a keypad capable of inputting a password on a screen. The electronic device 101 may encrypt the password input by the user and transmit it to the issuer server 450. Upon receiving a result of authentication success from the issuer server 450, the electronic device 101 may display the authentication success as shown in FIG. 19E, and may perform a final phone payment to complete the payment as shown in FIG. 19F.

If the attempt to perform the biometric authentication payment has failed whereas the payment authentication payment is successful as in the aforementioned embodiment, although not shown in the figure, the electronic device 101 and the issuer server 450 may change the biometric authentication information storage/registration state configured therein to an unstored/unregistered state.

In addition, when the biometric authentication information storage/registration state of the electronic device 101 and issuer server 450 is the unstored/unregistered state, biometric authentication information may also be registered when a next biometric authentication payment is attempted, which is much simpler and more usable than the existing method which requires separate registration.

According to various embodiments, a method of operating an electronic device (e.g., the electronic device 101) may include, when registered for a first time use, generating a parameter for biometric authentication verification and an encrypted password for password authentication verification and transmitting the generated parameter and password to the server, in order to register, with the server, biometric authentication information for biometric authentication verification and a password for password authentication, when a payment is made, performing user authentication by using at least one of the biometric authentication and the password authentication, and when it is necessary to change the biometric authentication information registered with the server, registering new biometric authentication information with the server in the process of the payment.

According to various embodiments, the performing of user authentication by using at least one of the biometric authentication and the password authentication when the payment is made may include requesting the server for an original biometric verification value, receiving, in response to the request, information indicating the original biometric verification value and a biometric authentication information registration state from the server, and determining to perform user authentication by using biometric authentication and/or password authentication, based on the received information indicating the biometric authentication information registration state and the information, stored in the memory, indicating the biometric authentication information storage state.

According to various embodiments, the determining to perform user authentication, based on the biometric authentication information registration state of the server and the biometric authentication information storage state stored in the memory, may include determining to perform user authentication by using biometric authentication when the information, received from the server, indicating the biometric authentication information registration state is in a registered state and the information indicating the biometric authentication information storage state is in a stored state, determining to perform user authentication by using biometric authentication when the information, received from the server, indicating the biometric authentication information registration state is in an unregistered state and the information indicating the biometric authentication information storage state is in an unstored state, determining to perform user authentication by using password authentication when the information, received from the server, indicating the biometric authentication information registration state is in the unregistered state and the information indicating the biometric authentication information storage state is in the stored state, and change the biometric authentication information storage state to the unstored state after the performing of the user authentication is complete, and determining to perform user authentication by using password authentication when the information, received from the server, indicating the biometric authentication information registration state is in the registered state and the information indicating the biometric authentication information storage state is in the unstored state.

According to various embodiments, the method may further include, when the information, received from the server, indicating the biometric authentication information registration state is in the unregistered state and the information indicating the biometric authentication information storage state is in the stored state, changing the biometric authentication information storage state to the unstored state, and when the information, received from the server, indicating the biometric authentication information registration state is in a registered state and the information indicating the biometric authentication information storage state is in the unstored state, after the user authentication is complete, requesting the server to change the biometric authentication information registration state to the unregistered state.

According to various embodiments, the performing of user authentication by using at least one of the biometric authentication and the password authentication when the payment is made may further include transmitting the parameter for biometric authentication verification to the server, receiving a biometric authentication verification result from the server, if the received verification result is a verification failure, transmitting an encrypted password for password authentication verification to the server, receiving a password verification result from the server, and if the received verification result is a verification success, changing the information indicating the biometric authentication information storage state to be in the unstored state and requesting the server to change the information indicating the biometric authentication information registration state to be in the unregistered state.

According to various embodiments, a method of operating a server (e.g., the issuer server 450), when registered for a first time use, may include, receiving a parameter for biometric authentication verification and an encrypted password for password authentication verification from the electronic device, storing the password in the memory by decoding the encrypted password, and storing, in the memory, biometric authentication information obtained by verifying biometric authentication, based on the parameter for biometric authentication verification, and when a payment is made, may further include verifying biometric authentication, based on the received parameter for biometric authentication verification and the stored biometric authentication information, and/or verifying password authentication by comparing a password obtained from the received encrypted password and the password stored in the memory, and when new registration for the biometric authentication information is necessary, storing, in the memory, new biometric authentication information registered while the payment is made using the biometric authentication.

According to various embodiments, the method, when the payment is made, may further include receiving a request for an original biometric authentication value from the electronic device, transmitting, in response to the request, information indicating the original biometric verification value and the biometric authentication information registration state to the electronic device, receiving the parameter for biometric authentication verification from the electronic device, verifying biometric authentication, based on the parameter for biometric authentication verification and the stored biometric authentication information, transmitting a result of the biometric authentication verification to the electronic device, if the result of the biometric authentication verification is a verification failure, receiving the encrypted password from the electronic device, verifying password authentication by comparing a password obtained from the received encrypted password and the password stored in the memory, transmitting a result of the password verification to the electronic device, if the result of the password verification is a verification success, receiving from the electronic device a request for changing information indicating the biometric authentication information registration state to be in an unregistered state, and changing the information indicating the biometric authentication information registration state to be in the unregistered state according to the request.

According to various embodiments, when new registration for the biometric authentication information is necessary, the storing, in the memory, new biometric authentication information registered while the payment is made using the biometric authentication may include receiving the parameter for biometric authentication verification from the electronic device, verifying biometric authentication, based on the parameter for biometric authentication verification and the stored biometric authentication information, and if the verification result is a success, storing, in the memory, biometric authentication information obtained from the parameter for biometric authentication verification.

According to various embodiments, the verifying of the biometric authentication may include identifying validity of the parameter for biometric authentication verification, obtaining original data by decoding the encrypted original data included in the parameter for biometric authentication verification with a private key of the server, identifying whether a legitimate payment app is used by using a hash value included in the decoded original data, identifying whether the original biometric verification value is identical to an original biometric verification value included in the decoded original data, identifying whether a specific period of time elapses after the original biometric verification value is issued, identifying whether biometric authentication public keys included in the stored biometric authentication information and the parameter for biometric authentication verification are identical, and performing, and verifying a signature of the signed original data.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication module configured to provide communication with a server;
a processor operatively coupled to the communication module; and
a memory operatively coupled to the processor and configured to store biometric information,
wherein the memory stores instructions which, when executed, cause the processor to:
when registered for a first time use, generate a parameter for biometric authentication verification and an encrypted password for password authentication verification and transmit the generated parameter and password to the server, in order to register, with the server, biometric authentication information for biometric authentication verification and a password for password authentication,
when a payment is made, use at least one of the biometric authentication or the password authentication to authenticate a user, and
when it is necessary to change the biometric authentication information registered with the server, register new biometric authentication information with the server in the process of the payment.

2. The electronic device of claim 1,
wherein the memory stores information indicating a biometric authentication information storage state, and
wherein the instructions cause, when the payment is made, the processor to:
request the server for an original biometric verification value,
receive, in response to the request, information indicating the original biometric verification value and a biometric authentication information registration state from the server, and
perform user authentication by using biometric authentication and/or password authentication, based on the received information indicating the biometric authentication information registration state and the information indicating the biometric authentication information storage state.

3. The electronic device of claim 2, wherein the instructions, when the payment is made, cause the processor to:
perform user authentication by using biometric authentication when the information, received from the server, indicating the biometric authentication information registration state is in a registered state and the information indicating the biometric authentication information storage state is in a stored state;
perform user authentication by using biometric authentication when the information, received from the server, indicating the biometric authentication information registration state is in an unregistered state and the information indicating the biometric authentication information storage state is in an unstored state;
perform user authentication by using password authentication when the information, received from the server, indicating the biometric authentication information registration state is in the unregistered state and the information indicating the biometric authentication information storage state is in the stored state, and change the biometric authentication information storage state to the unstored state after the performing of the user authentication is complete; and
perform user authentication by using password authentication when the information, received from the server, indicating the biometric authentication information registration state is in the registered state and the information indicating the biometric authentication information storage state is in the unstored state, and after the performing of the user authentication is complete, request the server to change the information indicating the biometric authentication information registration state to be in the unregistered state.

4. The electronic device of claim 2, wherein the instructions, when the payment is made, cause the processor to:
transmit the parameter for biometric authentication verification to the server;
receive a biometric authentication verification result from the server;
if the received verification result is a verification failure, transmit an encrypted password for password authentication verification to the server;
receive a password verification result from the server; and
if the received verification result is a verification success, change the information indicating the biometric authentication information storage state to the unstored state, and request the server to change the information indicating the biometric authentication information registration state to be in the unregistered state.

5. The electronic device of claim 2, wherein the instructions, when the payment is made, cause the processor to:
generate an object reference value;
generate a secure object in which the object reference value is encrypted;
generate original data including the original biometric verification value, the secure object, and a hash value indicating an app used for the payment; and
generate the parameter for biometric authentication verification, based on the original data.

6. A server comprising:
a communication module configured to provide communication with an electronic device;
a processor operatively coupled to the communication module; and
a memory operatively coupled to the processor and configured to store biometric authentication information,
wherein the memory stores instructions which, when executed, cause the processor to:
when registered for a first time use, receive a parameter for biometric authentication verification and an encrypted password for password authentication verification from the electronic device, store the password in the memory by decoding the encrypted password, and store, in the memory, biometric authentication information obtained by verifying biometric authentication, based on the parameter for biometric authentication verification,
when a payment is made using the biometric authentication, verify biometric authentication, based on the received parameter for biometric authentication verification and the stored biometric authentication information
when the payment is made using the password authentication, verify password authentication by comparing a password obtained from the received encrypted password and the password stored in the memory, and
when new registration for the biometric authentication information is necessary, store, in the memory, new biometric authentication information registered while the payment is made using the biometric authentication.

7. The server of claim 6,
wherein the memory stores information indicating a biometric authentication information registration state, and
wherein the instructions, when the payment is made, cause the processor to:
receive a request for an original biometric authentication value from the electronic device, and
transmit, in response to the request, information indicating the original biometric verification value and the biometric authentication information registration state to the electronic device.

8. The server of claim 7, wherein the instructions, when the payment is made, cause the processor to:
receive the parameter for biometric authentication verification from the electronic device;
verify biometric authentication, based on the parameter for biometric authentication verification and the stored biometric authentication information;
transmit a result of the biometric authentication verification to the electronic device;
if the result of the biometric authentication verification is a verification failure, receive the encrypted password from the electronic device;
verify password authentication by comparing a password obtained from the received encrypted password and the password stored in the memory;
transmit a result of the password verification to the electronic device;
if the result of the password verification is a verification success, receive from the electronic device a request for changing information indicating the biometric authentication information registration state to be in an unregistered state; and
change the information indicating the biometric authentication information registration state to be in the unregistered state.

9. The server of claim 7, wherein the instructions, when the payment is made, cause the processor to:
receive the parameter for biometric authentication verification from the electronic device;
verify biometric authentication, based on the parameter for biometric authentication verification;
if the verification result is a success, register biometric authentication information obtained from the parameter for biometric authentication verification, by storing the biometric authentication information in the memory; and
transmit the verification result to the electronic device.

10. The server of claim 7, wherein the instructions, when the payment is made, cause the processor to:
identify validity of the parameter for biometric authentication verification;
obtain original data by decoding the encrypted original data with a private key of the server;
identify whether an app used in the payment is legitimate by using a hash value included in the decoded original data and indicating the app to be used in the payment;
determine whether the original biometric verification value is identical to an original biometric verification value included in the decoded original data;
determine whether a specific period of time elapses after the original biometric verification value is issued;
identify whether biometric authentication public keys included in the stored biometric authentication information and the parameter for biometric authentication verification are identical; and
perform the biometric authentication verification by verifying a signature of the signed original data.

11. A method of operating an electronic device, the method comprising:
when registered for a first time use, generating a parameter for biometric authentication verification and an encrypted password for password authentication verification and transmitting the generated parameter and password to a server, in order to register, with the server, biometric authentication information for biometric authentication verification and a password for password authentication;
when a payment is made, performing user authentication by using at least one of the biometric authentication or the password authentication; and
when it is necessary to change the biometric authentication information registered with the server, registering new biometric authentication information with the server in a process of the payment.

12. The method of claim 11, wherein the performing of user authentication by using at least one of the biometric authentication or the password authentication when the payment is made comprises:
requesting the server for an original biometric verification value;
receiving, in response to the request, information indicating the original biometric verification value and a biometric authentication information registration state from the server; and
determining to perform user authentication by using biometric authentication or password authentication, based on the received information indicating the biometric authentication information registration state and the information, stored in a memory, indicating the biometric authentication information storage state.

13. The method of claim 12, wherein the determining to perform user authentication, based on the biometric authentication information registration state of the server and the biometric authentication information storage state stored in the memory, comprises:
determining to perform user authentication by using biometric authentication when the information, received from the server, indicating the biometric authentication information registration state is in a registered state and the information indicating the biometric authentication information storage state is in a stored state;
determining to perform user authentication by using biometric authentication when the information, received from the server, indicating the biometric authentication information registration state is in an unregistered state and the information indicating the biometric authentication information storage state is in an unstored state;
determining to perform user authentication by using password authentication when the information, received from the server, indicating the biometric authentication information registration state is in the unregistered state and the information indicating the biometric authentication information storage state is in the stored state, and change the biometric authentication information storage state to the unstored state after the performing of the user authentication is complete; and
determining to perform user authentication by using password authentication when the information, received from the server, indicating the biometric authentication information registration state is in the registered state and the information indicating the biometric authentication information storage state is in the unstored state.

14. The method of claim 12, further comprising:
transmitting the parameter for biometric authentication verification to the server;
receiving a biometric authentication verification result from the server;
if the received verification result is a verification failure, transmitting an encrypted password for password authentication verification to the server;
receiving a password
verification result from the server; and
if the received verification result is a verification success, changing the information indicating the biometric authentication information
storage state to the unstored state, and requesting the server to change the information indicating the biometric authentication information registration state to be in the unregistered state.

15. The method of claim 12, further comprising:
generating an object reference value;
generating a secure object in which the object reference value is encrypted;
generating original data including the original biometric verification value, the secure object, and a hash value indicating an app used for the payment; and
generating the parameter for biometric authentication verification, based on the original data.
